(19) United States
(12) Patent Application Publication
(10) Pub. No.: US 2016/0169786 A1
(43) Pub. Date: Jun. 16, 2016

(54) AUTOMATED FLOW CYTOMETRY ANALYSIS METHOD AND SYSTEM

(71) Applicant: NEOGENOMICS LABORATORIES, INC., Fort Meyers, FL (US)

(72) Inventors: Maher ALBITAR, Valley Center, CA (US); Hong ZHANG, Savannah, GA (US)

(21) Appl. No.: 14/965,640

(22) Filed: Dec. 10, 2015

Related U.S. Application Data
(60) Provisional application No. 62/090,316, filed on Dec. 10, 2014.

(51) Int. Cl. G01N 15/14; G06K 9/00; G06T 7/00; C40B 30/02

(52) U.S. Cl. CPC G01N 15/1429; C40B 30/02; G01N 15/1436; G06K 9/00127; G06T 7/0012; G01N 2015/0065

(57) ABSTRACT

An automated method and system are provided for receiving an input of flow cytometry data and analyzing the data using a hierarchical arrangement of analytical elements, each of which utilizes a support vector machine to automatically classify the data into different subpopulations to recognize a pattern within the data. The pattern may be used to generate a diagnostic prediction for a patient or to identify patterns within samples collected from multiple subjects.

### RELATED APPLICATIONS

This application claims the benefit of the priority of U.S. Provisional Application No. 62/090,316, filed Dec. 10, 2014, which is incorporated herein by reference in its entirety. This application is also related to the subject matter of U.S. Pat. No. 8,628,810, the disclosure of which is incorporated herein by reference in its entirety.

### FIELD OF THE INVENTION

The present invention relates to a method and system for automated analysis of distributional data, particularly flow cytometry data, using support vector machines.

### BACKGROUND OF THE INVENTION

Flow cytometry is the measurement of characteristics of minute particles suspended in a flowing liquid stream. A focused beam of laser light illuminates each moving particle and light is scattered in all directions. Detectors placed forward of the intersection point or orthogonal to the laser beam receive the pulses of scattered light, generating signals which are input into a computer analyzer for interpretation. The total amount of forward scattered light detected depends on particle size and refractive index but is closely correlated with cross-sectional area of the particle as seen by the laser, whereas the amount of side scattered light can indicate shape or granularity.

One of the most widely used applications of flow cytometry is that of cellular analysis for medical diagnostics, where the particles of interest are cells suspended in a saline-containing solution. Flow cytometry techniques offer a high-throughput system for collecting large amounts of cell data. Flow cytometry is an effective tool in detecting abnormalities such as MM, CLL, LGL, AML, ALL, MDS, CMML, Lymphoma, MBL, etc. from samples of various types including bone marrow, peripheral blood, and tissue. Further properties of the cell, such as surface molecules or intracellular constituents, can also be accurately quantitated if the cellular marker of interest can be labeled with a fluorescent dye; for example, an antibody-fluorescent dye conjugate may be used to attach to specific surface or intracellular receptors. Immunophenotyping by characterizing cells at different stages of development through the use of fluorescent-labeled monoclonal antibodies against surface markers is one of the most common applications of flow cytometry. Other dyes have been developed which bind to particular structures (e.g., DNA, mitochondria) or are sensitive to the local chemistry (e.g., Ca++ concentration, pH, etc.).

While flow cytometry is widely used in medical diagnostics, it is also useful in non-medical applications, such as water or other liquid analysis. For example, seawater may be analyzed to identify presence of or types of bacteria or other organisms, milk can be analyzed to test for microbes, and fuels may be tested for particulate contaminants or additives.

The laser beam that is used is of a suitable color to excite the fluorochrome or fluorochromes selected. The quantity of fluorescent light emitted can be correlated with the expression of the cellular marker in question. Each flow cytometer is usually able to detect many different fluorochromes simultaneously, depending on its configuration. In some instruments, multiple fluorochromes may be analyzed simultaneously by using multiple lasers emitting at different wavelengths. For example, the FACSCalibur™ flow cytometry system available from Becton Dickinson (Franklin Lakes, N.J.) is a multi-color flow cytometer that is configured for four-color operation. The fluorescence emission from each cell is collected by a series of photomultiplier tubes, and the subsequent electrical events are collected and analyzed on a computer that assigns a fluorescence intensity value to each signal in Flow Cytometry Standard (FCS) data files. Analysis of the data involves identifying intersections or unions of polygonal regions in hyperspace that are used to filter or “gate” data and define a subset of sub-population of events for further analysis or sorting.

The International Society for Analytical Cytology (ISAC) has adopted the FCS Data File Standard for the common representation of FCM data. This standard is supported by all of the major analytical instruments to record the measurements from a sample run through a cytometer, allowing researchers and clinicians to choose among a number of commercially-available instruments and software without encountering major data compatibility issues. However, this standard stops short of describing a protocol for computational post-processing and data analysis.

Due to the large amount of data present in a flow cytometry analysis, it is often difficult to fully utilize the data through a manual process. The high dimensionality of data also makes it infeasible to use traditional statistical methods and learning techniques such as artificial neural networks. The support vector machine is a kernel based machine learning technique capable of processing high dimensional data. It can be an effective tool in handling the flow data with an appropriately designed kernel.

The flow data of a single case typically consist of multiple tubes. Each tube may contain simultaneous measurements of multiple assays. Each run typically collects over 10⁴ events when all the assays are measured, which can produce on the order of 10⁶ measurements for analysis.

The traditional approach in analyzing the flow data typically involves a “gating” method on the data to separate certain groups of cells and a manual examination of a large collection of 2D plots of the data with two parameters at a time. The features of flow cytometry data useful for diagnostics are usually presented in the distribution of attribute values in a high dimensional space. As a result it is difficult for human readers to perceive the convoluted, high dimensional patterns within the data.

Modern technological advancements, such as flow cytometry, have created a vast amount of data in many different forms. One of the greatest challenges presented to computer and information scientists by this information explosion is to develop effective methods to process large quantities of data and extract meaningful information. Traditional statistical methods, though effective on low dimensional data, have proven to be inadequate in processing the “new data” which are often characterized by high complexity and high dimensionality. In particular, the so called “curse of dimensionality” is a serious limitation on the classical statistical tools. Machine learning represents a promising new paradigm in data processing and analysis to overcome the limitations. It uses a “data-driven” approach to automatically “learn” a system, which can be used to make classifications or predictions on future data. Support Vector Machine (SVM) is a state-of-the-art machine learning technology that has revolutionized the field of machine learning and has provided real, effective solutions to many difficult data analysis problems.

SVM combines the concepts of an optimal hyperplane in a high-dimensional inner product space (often an infinite-dimensional Hilbert space) and a kernel function defined on the input space to achieve the flexibility of data representations, computational efficiency, and regularization on model capacities. SVM can be used to solve both classification (pattern recognition) and regression (prediction) problems. A typical SVM pattern recognition setting is given below.

Given a set of training data:

xᵢ, yᵢ i=1,2, . . . , m

The SVM training can be formulated as a problem of finding an optimal hyperplane:

$$min \frac{1}{2} {‖ w ‖}^{2} + \frac{C}{m} {\sum }_{i = 1}^{m} {ξ}_{i} , {ξ}_{i} \geq 0 , {y}_{i} ( < Φ ( {x}_{i} ) , w > + b ) \geq 1 - {ξ}_{i}$$

Using Lagrange multipliers, it is transformed to the dual problem:

$$max {\sum }_{i = 1}^{m} {α}_{i} - \frac{1}{2} {\sum }_{i , j = 1}^{m} {α}_{i} {α}_{j} {y}_{i} {y}_{j} k ( {x}_{i} , {x}_{j} ) , {α}_{i} \geq 0 , {\sum }_{i = 1}^{m} {α}_{i} {y}_{i} = 0$$

Solving the quadratic programming problem, we have the SVM solution:

$$f ( x ) = sgn ( {\sum }_{i = 1}^{m} {α}_{i} {y}_{i} k ( x , {x}_{i} ) + b )$$

Due to the complexity of the flow cytometry data, it is difficult to explicitly extract necessary features or define patterns that will predict cytogenetic results. The SVM based system offers a distinctive advantage that it requires only a similarity measure between examples to construct the classifier.

### BRIEF SUMMARY OF THE INVENTION

According to the present invention, a computer-assisted flow cytometry data analysis system is provided to automate most of the tedious steps of the analysis process, by using advanced machine learning technologies and other mathematical algorithms. Support Vector Machines (SVM) with custom distribution kernel are used to detect abnormal flow distributions. Gaussian Mixture models (GMM) are applied to automatic clustering and gating. A special graph algorithm is developed for automatic gate recognition.

This system retains the traditional features such as gating definition and adjustment, 2D plots, and statistical tables. However, it provides automation at all analysis steps. Furthermore, the SVM method facilitates analyses far beyond the 2D or 3D limitation in the traditional approach.

The inventive system provides automated flow cytometry data analysis including automatic gate prediction, automatic determination of normal versus abnormal for each plot (each marker), automatic determination of abnormal results based on summary table, automated determination of disease type based on combination of abnormalities (summary table, individual plots, and gates distribution). The system provides a user with the ability to train and customize designation of normal versus abnormal. In some embodiments, the flow cytometry analysis system provides means for distinguishing normal from abnormal by displaying labeled plots and values with a visually-distinctive feature, which can be achieved using a specified color, e.g., red, by highlighting, underlining bolding, or any other visually-detectable indicator so clearly flag abnormal results for the system user. The flagged results will be recorded in the associated patient records for evaluation by a pathologist, physician or other medical personnel.

The inventive system will help pathologists significantly improve the accuracy and efficiency in analyzing flow data. It will also provide a powerful tool in discovery of new patterns in flow cytometry.

Support vector machines, examples of which are generally disclosed in U.S. Pat. No. 6,760,715, U.S. Pat. No. 7,117,188 and U.S. Pat. No. 6,996,549, among others, which are incorporated herein by reference, are utilized to analyze flow cytometry data generated by a conventional commercial flow cytometry set-up. Exemplary systems for practicing flow cytometry measurement are described in U.S. Pat. No. 5,872,627, and U.S. Pat. No. 4,284,412, which are incorporated herein by reference. In the specific examples described herein, the data relates to a medical diagnostic application, specifically for detecting hematological conditions such as myelodysplastic syndrome (MDS). Flow cytometric immunophenotyping has proven to be an accurate and highly sensitive method for detection of quantitative and qualitative abnormalities in hematopoietic cells even when combined morphology and cytogenetics were non-diagnostic. The automated flow cytometry data analysis system disclosed herein provides the ability to automatically analyze the huge volumes of data generated during flow cytometry measurement, enhancing the accuracy, repeatability and versatility of flow cytometric methods. Such a capability enhances not only the diagnostic value of flow cytometry but also expands research applications of the method by enabling collection and analysis of massive amounts of flow cytometry data from many subjects for data mining and pattern recognition that go far beyond current limited approaches.

In one aspect of the invention, a method for analysis and classification of flow cytometry data, wherein the flow cytometry data comprises a plurality of features that describe the data, includes the steps of: downloading an input dataset comprising flow cytometry events for a population of cells into a computer system comprising a processor and a storage device, wherein the processor is programmed to execute at least one support vector machine and performs the steps of: defining a hierarchical structure of analytical elements, each analytical element corresponding to a different gating definition, wherein each analytical element applies a gating algorithm to classify a subpopulation of cells according to predetermined criteria on a combination of parameters, wherein the classification is performed using a support vector machine with a distributional kernel; and generating an output display at a display device with an identification of a flow cytometry data classification. In some embodiments, the method further includes selecting a subpopulation of cells and analyzing the selected subpopulation of cells using a different analytical element that applies a different gating algorithm to further classify the subpopulation. In a preferred embodiment, the distributional kernel comprises a Bhattacharya affinity having the form:

$$k ( p , q ) = {e}^{- ρ ( p , q )} = {\sqrt{\frac{\vert ( {\sum }_{1} + {\sum }_{2} ) \text{/} 2 \vert}{\sqrt{\vert {\sum }_{1} \vert \cdot \vert {\sum }_{2} \vert}}}}^{- 1} exp \{ - \frac{1}{8} {{( {M}_{2} - {M}_{1} )}^{T} [ \frac{{\sum }_{1} + {\sum }_{2}}{2} ]}^{- 1} ( {M}_{2} - {M}_{1} ) \} ,$$

where p and q are input data points, M is the mean of a normal distribution and is a covariance matrix. The hierarchical structure may be a tree having a plurality of branches, and further includes a conclusion analysis step for combining results produced by each branch into a diagnostic classification. The diagnostic classification may comprise either presence or absence of a disease. The different gating definition may be selected from the group consisting of sample tube identity, debris vs. non-debris, granulocytes, monocytes, lymphocytes, negative marker intensity and diminished marker intensity.

In another aspect of the invention, a method for automatically analyzing flow cytometry data includes the steps of detecting side scatter and forward scatter events for a sample; generating a plurality of plots of the side scatter and forward scatter events in two- or three dimensions, the plurality of plots comprising flow cytometry data; processing the plurality of plots using a hierarchical structure of analytical elements, each analytical element corresponding to a different gating definition, wherein each analytical element applies a gating algorithm to classify a subpopulation of cells according to predetermined criteria on a combination of parameters, wherein the classification is performed using a distributional kernel; and generating an output at a display device with an identification of one or more flow cytometry data classifications. The method may further comprise selecting a subpopulation of cells and analyzing the selected subpopulation of cells using a different analytical element that applies a different gating algorithm to further classify the subpopulation. In a preferred embodiment, the distributional kernel is a Bhattacharya affinity having the form

$$k ( p , q ) = {e}^{- ρ ( p , q )} = {\sqrt{\frac{\vert ( {\sum }_{1} + {\sum }_{2} ) \text{/} 2 \vert}{\sqrt{\vert {\sum }_{1} \vert \cdot \vert {\sum }_{2} \vert}}}}^{- 1} exp \{ - \frac{1}{8} {{( {M}_{2} - {M}_{1} )}^{T} [ \frac{{\sum }_{1} + {\sum }_{2}}{2} ]}^{- 1} ( {M}_{2} - {M}_{1} ) \} ,$$

where p and q are input data points, M is the mean of a normal distribution and is a covariance matrix. The hierarchical structure may be a tree having a plurality of branches, and may further include a conclusion analysis step for combining results produced by each branch into a diagnostic classification. The diagnostic classification may be either presence or absence of a disease. The different gating definition is selected from the group consisting of sample tube identity, debris vs. non-debris, granulocytes, monocytes, lymphocytes, negative marker intensity and diminished marker intensity.

In still another aspect of the invention, a system for automated analysis of flow cytometry data includes a computer processor in communication with a memory having stored therein flow cytometry data comprising a plurality of assays performed on a plurality of samples comprising cells, the flow cytometry data comprising side scatter and forward scatter events; and a computer-program product embodied in a non-transitory computer readable medium, the computer-program product comprising instructions for causing the computer processor to: receive the flow cytometry data; generate a plurality of plots of the side scatter and forward scatter events in two- or three dimensions; process the plurality of plots using a hierarchical structure of analytical elements, each analytical element corresponding to a different gating definition, wherein each analytical element applies a gating algorithm to classify a subpopulation of cells within the samples according to predetermined criteria on a combination of parameters, wherein the classification is performed using a distributional kernel; and generate an output at a display device with an identification of one or more flow cytometry data classifications of the cells. The computer-program product may further include instructions for causing the computer processor to select a subpopulation of cells and analyze the selected subpopulation of cells using a different analytical element that applies a different gating algorithm to further classify the subpopulation. In a preferred embodiment, the distributional kernel comprises a Bhattacharya affinity having the form:

$$k ( p , q ) = {e}^{- ρ ( p , q )} = {\sqrt{\frac{\vert ( {\sum }_{1} + {\sum }_{2} ) \text{/} 2 \vert}{\sqrt{\vert {\sum }_{1} \vert \cdot \vert {\sum }_{2} \vert}}}}^{- 1} exp \{ - \frac{1}{8} {{( {M}_{2} - {M}_{1} )}^{T} [ \frac{{\sum }_{1} + {\sum }_{2}}{2} ]}^{- 1} ( {M}_{2} - {M}_{1} ) \} ,$$

where p and q are input data points, M is the mean of a normal distribution and Σ is a covariance matrix. The hierarchical structure may be a tree having a plurality of branches, and the system may further include a conclusion analysis step for combining results produced by each branch into a diagnostic classification. In some embodiments, the diagnostic classification comprises either presence or absence of a disease. The different gating definition is selected from the group consisting of sample tube identity, debris vs. non-debris, granulocytes, monocytes, lymphocytes, negative marker intensity and diminished marker intensity. In some embodiments, the memory is associated with a flow cytometry instrument and is specific to an individual subject, while in other embodiments, the memory may be a database configured for storing accumulated flow cytometry data generated from samples collected from multiple subjects.

### BRIEF DESCRIPTION OF THE DRAWINGS

FIG. 1 is a diagrammatic view of a system for automated collection and analysis of flow cytometry data according to the present invention.

FIG. 2 is an exemplary log-log display of distributions of populations of interest in flow cytometry analysis for MDS.

FIG. 3 is a flow chart of the data analysis method according to the present invention.

FIG. 4 is a diagrammatic view of an exemplary hierarchical structure for analysis according to an embodiment of the invention.

FIG. 5 is a block diagram of the structure of each node of the tree of FIG. 4 according to an implementation of the inventive system.

FIGS. 6A and 6B are examples of analysis results generated by the inventive system.

FIG. 7 is a flow diagram for an exemplary branch of an analysis tree according to an embodiment of the invention.

FIGS. 8A-8E are sample screenshots for an exemplary analysis sequence of the branch of FIG. 7.

FIG. 9 is a sample screenshot of a 3-dimensional plot produced according to an embodiment of the flow cytometry analysis system.

FIG. 10 is a sample screenshot of analysis results according to an embodiment of the invention.

FIGS. 11A-11F are sample plots generated for six different analyses in which FIGS. 11A-11C and 11F represent normal results and FIGS. 11D-11E are highlighted to indicate abnormal results.

FIG. 12 is a sample spreadsheet listing measured and calculated values for different subpopulations.

FIG. 13 illustrates parameters for a subpopulation and the corresponding flow cytometry data.

FIG. 14 illustrates parameters for another subpopulation and the corresponding flow cytometry data.

### DETAILED DESCRIPTION OF AN EXEMPLARY EMBODIMENT

According to the present invention, a method and system are provided for analysis of flow cytometry data. In particular, the inventive method includes creation of kernels for use in the analysis of data of distributional nature. An input data p in a flow cytometry application is a collection of a large number of points in a space. For example, an image can be regarded as a set of points in a 2-dimensional space. After proper normalizations, p may be viewed as a probability distribution. To define a kernel on two such input data p and q to capture the distributional trends, one must define a function on p and q that measures the similarity between the two entire distributions rather than just the individual points in the distributions.

One way to construct such a “distributional kernel” is to use a distance function (divergence) between the two distributions. If ρ(p, q) is a distance function, then the following is a kernel

k(p,q)=e^{-ρ(p,q)}. (1)

There are many distance functions that measure the discrepancy between two probability distributions. Kullback-Leibler divergence, Bhattacharya affinity, Jeffrey's divergence, Mahalanobis distance, Kolmogorov variational distance, and expected conditional entropy are all examples of such distances. Given a distance function, a kernel can be constructed based on the above formula.

For example, a special custom kernel can be constructed based on Bhattacharya affinity. For normal distributions with mean M and covariance matrix Σ, Bhattacharya affinity has the form:

$$ρ ( p , q ) = \frac{1}{8} {{( {M}_{2} - {M}_{1} )}^{T} [ \frac{{\sum }_{1} + {\sum }_{2}}{2} ]}^{- 1} ( {M}_{2} - {M}_{1} ) + \frac{1}{2} ln \frac{\vert ( {\sum }_{1} + {\sum }_{2} ) \text{/} 2 \vert}{\sqrt{\vert {\sum }_{1} \vert \cdot \vert {\sum }_{2} \vert}} \qquad ( 2 )$$

From this distance function, a new kernel is defined using the above equation.

$$k ( p , q ) = {e}^{- ρ ( p , q )} = {\sqrt{\frac{\vert ( {\sum }_{1} + {\sum }_{2} ) \text{/} 2 \vert}{\sqrt{\vert {\sum }_{1} \vert \cdot \vert {\sum }_{2} \vert}}}}^{- 1} exp \{ - \frac{1}{8} {{( {M}_{2} - {M}_{1} )}^{T} [ \frac{{\sum }_{1} + {\sum }_{2}}{2} ]}^{- 1} ( {M}_{2} - {M}_{1} ) \} \qquad ( 3 )$$

This distributional kernel is computationally efficient with a linear complexity and can handle large quantities of input data. A typical density estimation method has a computational complexity O(n²), which might be too high for some applications. The inventive distributional kernels can be applied directly in a SVM or other machine learning systems to create classifiers and other predictive systems. The distributional kernels provide some distinctive advantages over the standard kernels that are frequently used in SVMs and other kernel machines. They capture the similarities between the overall distributions of the large data components, which may be crucial in some applications.

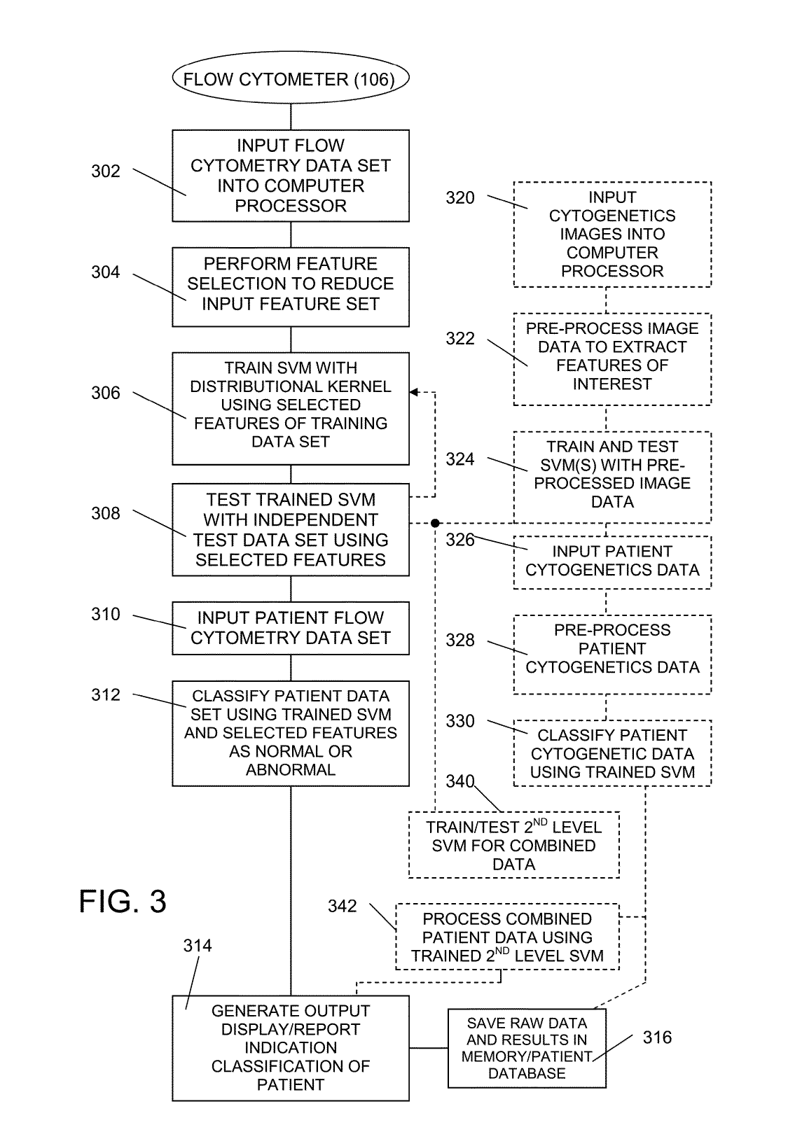

FIG. 3 provides an exemplary process flow used for analysis of flow cytometry data. As will be readily apparent to those in the art, flow cytometry data is provided as an example of distributional data, and other types of distributional data may be processed and classified using the techniques described in the following.

The raw data generated by the flow cytometer 106 is input into a computer processing system (step 302) which includes at least a memory and a processor that is programmed to execute one or more support vector machines. A typical personal computer (PC) or APPLE® MAC®-type processor is suitable for such processing. The input data set may be divided into two portions, one for use in training the support vector machine, the other for use in testing the effectiveness of the training. In step 304, feature selection algorithms are run on the training data set by executing one or more feature selection programs within the processor. In step 306, the training data set with the reduced feature set is processed using a support vector machine with a distributional kernel such as the Bhattacharya affinity-based kernel. The effectiveness of the training step is evaluated in step 308 by extracting the data corresponding to the features selected in step 304 in the independent test data set and processing the test data using the trained SVM with the distributional kernel. If the results of the test indicate a less than optimal result, the SVM will be re-trained and retested until an optimal solution is attained. If the training is determined to be satisfactory, live data corresponding to flow cytometry measurements taken on a patient sample is input into the processor in step 310. The features that were selected in step 304 are selected from the patient data and processed through the trained and tested SVM with distributional kernel in step 312, with the result being a classification of the patient sample as normal or abnormal. In step 314, a report summarizing the results is generated which may be displayed on a computer monitor 122, on a printed report 124, and/or transmitted via e-mail or other network file transfer system to a research or clinical laboratory, hospital or physician's office. Histograms with one- and two-dimensional representations of the data groupings may also be displayed and/or printed. The results will also be stored, along with the raw data, histograms and other patient data within the computer memory or a patient database.

An optional additional diagnostic procedure may be combined with the flow cytometry data and results to provide enhanced confidence in an automated analysis system. Using a scheme similar to that disclosed in U.S. Pat. No. 7,383,237, of Zhang et al., which is incorporated herein by reference, the results of the flow cytometry testing may be combined with other types of testing. FIG. 3 illustrates an optional flow path for performing computer-aided image analysis of cytogenetic data using SVMs by extracting features of interest from images of chromosomes generated in conventional procedures such as karyotyping or fluorescent in-situ hybridization (FISH), to identify deletions, translocations, inversions and other abnormalities. In step 320, training image data is input into the computer processor where it is pre-processed to identify and extract features of interest. In general, the training image data is pre-processed to identify features of interest (step 322), then used to train the image-processing SVM. Test image data are then used to verify that an optimal solution has been attained (step 324). If not, step 324 will be repeated and the SVM will be re-trained and re-tested. If the optimal solution has been achieved, live patient image data will be input (step 326) for pre-processing (step 328) and classification (step 330).

In a preferred approach, as described in U.S. Pat. No. 7,383,237, each feature of interest within the image is separately pre-processed (step 322) and processed by an SVM which is optimized for that feature. The results of the analyses of all features of interest are combined in a 2^{nd} level image-processing SVM to generate an output classifying the entire image. The trained SVM(s) is/are tested using pre-processed image test data (step 324). If the solution is optimal, images corresponding to live patient data (the same patient for whom the flow cytometry analysis is performed) are input into the processor (step 326). The patient image data is pre-processed (step 328) to identify the features of interest and each feature of interest is processed through the trained first level SVMs that are optimized for the specific feature. The combined results of the analyses of the features of interest are combined and input into the trained 2^{nd} level image-processing SVM to generate an output classifying the entire image (step 330).

The results of step 330 can be communicated for storage in the patient's file in the patient database (step 316) and/or will be input into a 2^{nd} level SVM for analysis in combination with the flow cytometry data results from step 312. This 2^{nd} level SVM will have already been trained and tested using the training and test data as indicated by the dotted lines between steps 308, 324 and 340. The results of step 316 and step 330 are combined for processing by trained 2^{nd} level SVM for combined analysis in step 342. The results of this combined processing with generally be a binary output, e.g., normal or abnormal, diseased or no disease, etc. The combined results may be output for display in step 314 and/or input into a memory or patient database for storage (step 316). Additional optional secondary flow paths may be provided to incorporate other types of data and analysis, such as expert analysis, patient history, etc., which may be combined to produce an ultimate diagnostic or prognostic score or other output that may be used for screening, monitoring and/or treatment.

### EXAMPLE 1

### Detection of Myelodysplastic Syndrome (MDS)

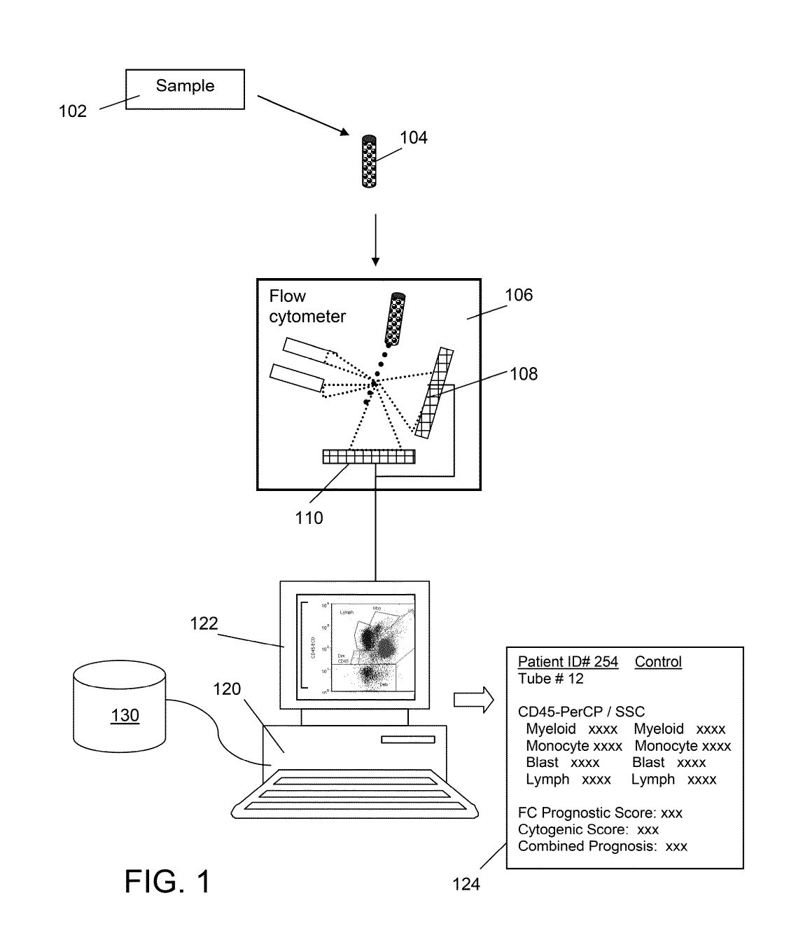

The object of the present study is to investigate the potential connections between Myelodysplastic Syndrome (MDS)-related chromosome abnormalities in cytogenetics and the patterns in flow cytometry data. This immunophenotyping analysis is one of the most common applications of flow cytometry and the protocols for sample collection and preparation are well known to those in the art. Following the sequence illustrated in FIG. 1, bone marrow aspirates 102 from patients suspected of having MDS are collected in a saline or sodium heparin solution to create a cell suspension in a number of tubes 104 or other containers that are adapted to introduce the suspension into the flow cell of flow cytometer system 106. Reagents containing monoclonal antibodies conjugated with different fluorochromes are introduced into the tubes, with each tube receiving different combinations of antibodies with each different combination conjugated with one of several possible fluorochromes. Flow cytometers are commercially available from numerous manufacturers including the FACSCalibur™ from Becton Dickinson (Franklin Lakes, N.J.) or the Cytoron/Absolute™ from Ortho Diagnostics (Raritan, N.J.). For the instant example, a FACSCalibur™ system was used for four-color measurement. As will be apparent to those in the art, such systems provide automated handling of multiple samples loaded into a carousel, so that the illustrations are intended to be diagrammatic, indicating only the presence of a sample within the flow cytometer's analyzer field. The forward scatter detector 108 and side scatter detectors 110 in the flow cytometer system 106 generate electrical signals corresponding to detected events as the cells are directed through the analysis stream. Fluorescence detectors, included among the side scatter detectors 110, measure the amplitudes of the fluorescent signals generated by expression of the antigens as indicated by the antibodies conjugated with the different fluorescent markers. Numerical values are generated based on pulse heights (amplitudes) measured by each of the various detectors. The resulting signals are input into a processor within computer workstation 120 and used to create histograms (single or dual parameter) corresponding to the detected events for display on a graphical display monitor 122. Analysis of this data according to the present invention, which involves classification of the input data according to normal or abnormal based on comparison to control samples, results in a report 124 which may be printed or displayed on the monitor 122. The raw data, histograms and report will also be saved in either or both of an internal memory in computer workstation 120 and a separate memory device, which may include a database server 130 which may be part of a data warehouse in a medical laboratory or other medical facility, for association with other records for the patient.

In an exemplary process sequence, the input dataset includes 77 cases (patients) that have both flow cytometry and cytogenetics data. All patients are suspected of having MDS. Among the 77 cases, 37 had chromosome abnormalities as indicated by cytogenetic testing, which involves microscopic examination of whole chromosomes for changes in number or structure. The remaining 40 were found to be negative under cytogenetics.

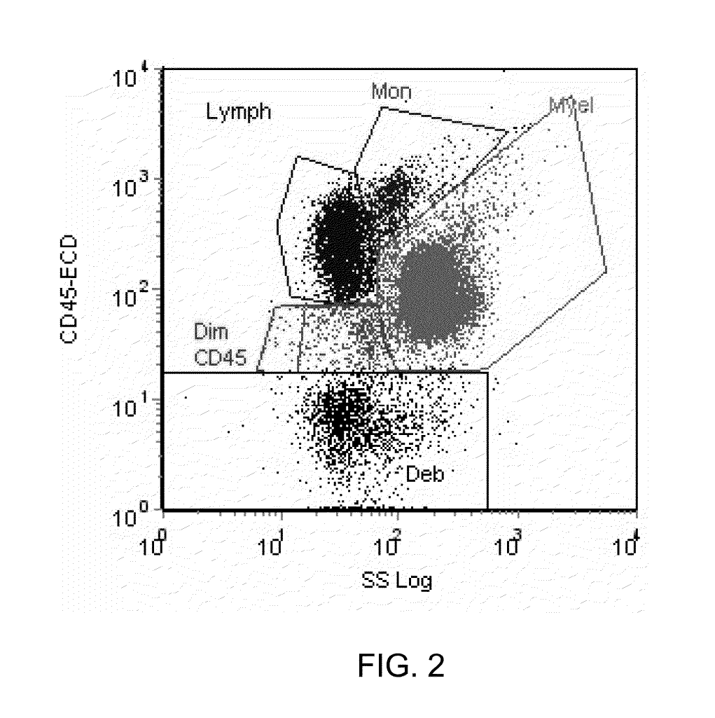

The aspirated bone marrow samples in suspension were divided among 13 tubes for each patient. In a standard 4-color immunofluorescence protocol, forward light scatter (F SC) and right angle light scatter (SSC) were collected along with 4-color antibody combinations to perform seven different assays, one of which was blank. Each case typically had 20,000-50,000 events where all of the assays are measured. The resulting flow cytometry dataset for each case had approximately 10⁶ measurements. FIG. 2 illustrates an exemplary histogram showing side scatter versus CD45 expression with the different cell populations marked.

For each of the 13 tubes, FSC and SSC were measured, allowing gating to exclude cellular debris, shown in the lower left corner of FIG. 2. In addition, different combinations of antigen specificities with fluorescence markers were used for each tube. Table 1 below lists the different combinations of monoclonal antibodies with the following markers: FITC (fluoroscein isothiocyanate), PE (phycoerythrin), PerCP (peridinin-chlorophyl), and APC (allophycocyanin). Monoclonal antibodies conjugated with the identified fluorescent markers are commercially available from a number of different sources including Becton-Dickinson Immunocytometry Systems (San Jose, Calif.), DakoCytomation (Carpinteria, Calif.), Caltag (Burlingame, Calif.) and Invitrogen Corporation (Camarillo, Calif.). The CD45 antibody, used for enumeration of mature lymphocytes, is included in each combination for validation of the lymphocyte gating.

TABLE 1

| Tube | FITC-conjugated | PE-conjugated | PerCP-conjugated | APC-conjugated |
|---|---|---|---|---|
| 1 | IgG1 | IgG1 + PI | CD45/2D1/IgG1 | IgG1 |
| 2 | IgG2b | IgG2b | CD45/2D1/IgG1 | IgG2b |
| 3 | CD8/SK1/IgG1 | CD2/RPA-2.10/IgG1 | CD45/2D1/IgG1 | CD4/SK3/IgG1 |
| 4 | CD7/M-T701/IgG1 | CD56/MY31/IgG1 | CD45/2D1/IgG1 | CD3/SK7/IgG1 |
| 5 | CD19/SJ25C1/IgG1 | CD23/M-L233/IgG1 | CD45/2D1/IgG1 | CD5/UCHT-2/IgG1 |
| 6 | CD22/S-HCL-1/IgG2b | CD10/HI10a/IgG1 | CD45/2D1/IgG1 | CD34/8G12/IgG1 |
| 7 | CD10/HI10a//IgG1 | CD11c/S-HCL-3/IgG2b | CD45/2D1/IgG1 | CD20/2H7/IgG2b |
| 8 | CD38/HB.7/IgG1 | Dako Kappa/F(ab)2rab | CD45/2D1/IgG1 | CD20/2H7/IgG2b |
| 9 | CD38/HB.7/IgG1 | Dako Lambda/F(ab)2rab | CD45/2D1/IgG1 | CD20/2H7/IgG2b |
| 10 | Kappa Caltag poly | Lambda Caltag poly | CD45/2D1/IgG1 | CD19/SJ25C1/IgG1 |
| 11 | HLA-DR/TU36/IgG2b | CD117/104D2 | CD45/2D1/IgG1 | CD11b/Mac-1/IgG1 |
| 12 | CD14/MoP9/IgG2b | CD13/L138/IgG1 | CD45/2D1/IgG1 | CD64/10.1/IgG1 |
| 13 | CD16/NKP15/IgG1 | CD33/P67.6/IgG1 | CD45/2D1/IgG1 | CD34/8G12/IgG1 |

In order to provide data for both training the SVM and for evaluation of the training, the entire dataset for the 77 cases was divided into a training set and an independent test set. Forty cases (20 positive and 20 negative as determined by cytogenetic testing) were used to train the SVM. The remaining 37 cases (17 positive and 20 negative) were used to form an independent test set.

The previously-described custom kernel based on the Bhattacharya affinity was used for analysis of the flow cytometry data to measure the discrepancy between two probability distributions.

Inclusion of data from all the assays in the classifier will not produce a system with the optimal performance. Therefore, a feature selection on the assays is conducted based on the training set. Two performance measures were applied in the feature selection step. The first feature selection method, the leave-one-out (LOO) error rate for SVM, involves training the SVM on the initial data set, then updating the scaling parameters by performing a gradient step so that LOO error decreases. These steps are repeated until a minimum of the LOO error is reached. A stopping criteria can be applied. The second feature selection method was the kernel alignment. Such a technique is described in U.S. Pat. No. 7,299,213 of Cristianini, which is incorporated herein by reference. Kernel alignment uses training data only and can be performed before training of the kernel machine takes place.

During the feature selection process, it was determined that a significant number of features would not contribute to the accurate classification of the data. The result of the feature selection procedure is given in the Table 2.

TABLE 2

| | Assay | | | Marker | | | |
|---|---|---|---|---|---|---|---|
| Tube # | Blank | FSC | SSC | FTIC | PE | PerCP | APC |
| 1 | 0 | 1 | 0 | 0 | 1 | 0 | 0 |
| 2 | 0 | 0 | 1 | 0 | 0 | 0 | 1 |
| 3 | 0 | 1 | 1 | 0 | 0 | 0 | 0 |
| 4 | 0 | 0 | 1 | 1 | 0 | 0 | 1 |
| 5 | 0 | 0 | 0 | 0 | 0 | 0 | 1 |
| 6 | 0 | 0 | 1 | 0 | 0 | 0 | 0 |
| 7 | 0 | 1 | 1 | 1 | 0 | 0 | 0 |
| 8 | 0 | 1 | 1 | 1 | 0 | 0 | 1 |
| 9 | 0 | 1 | 1 | 1 | 0 | 0 | 0 |
| 10 | 0 | 0 | 1 | 1 | 0 | 0 | 0 |
| 11 | 0 | 1 | 1 | 0 | 0 | 0 | 1 |
| 12 | 0 | 0 | 0 | 0 | 0 | 0 | 0 |
| 13 | 0 | 0 | 0 | 0 | 0 | 0 | 0 |

A value of “1” in an entry of Table 2 means that a particular assay (tube/assay combination) is selected; “0” means that the assay was not selected. This reduced the number of features to be considered from each case for classifying the data to 26, down from the original 91. The data from the reduced number of assays was then used to train the SVM with the distributional kernel.

Using the selected assays, the trained SVM is then tested with the 37 independent cases. The results at the cutoff of 0 were summarized using the conventional statistical measure of the performance of a binary classification test. Sensitivity, or recall rate, provides a measure of the proportion of correctly classified positives to the total number of positives as determined by cytogenetic testing. Specificity measures the proportion of negatives which are correctly identified. The results of analysis of the test data were as follows:

Sensitivity: 15/17=88% Specificity: 19/20=95%

This produces an overall error rate of 3/37=8%. Using the estimated standard deviation for binomial distribution, σ=0.0449, the test produced a 95% confidence level that the error rate would be less than 15%.

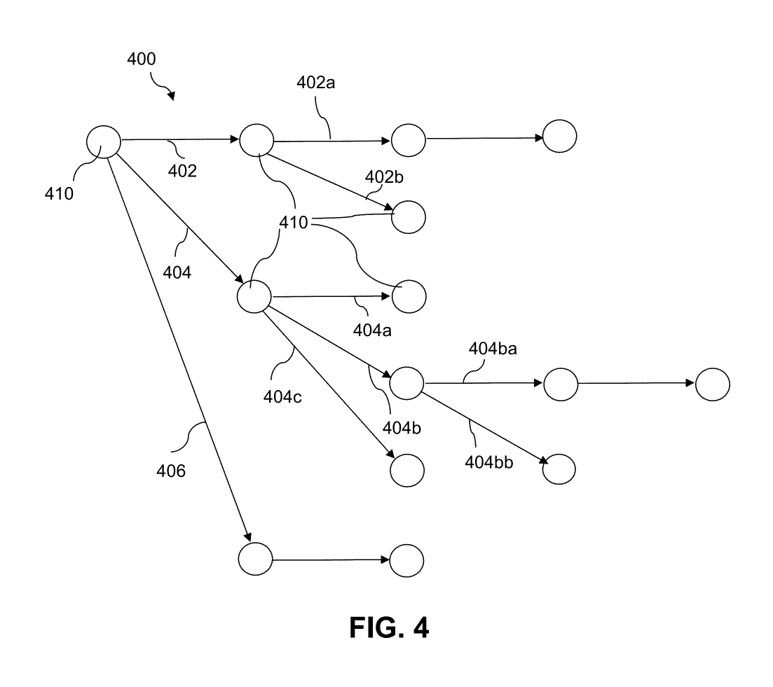

FIG. 4 illustrates the hierarchical structure of the inventive system, represented by a rooted tree 400. Each node 410 of the tree represents a basic analytical element that performs various tasks pertaining to a specific gated flow data. Depending on the analysis being performed at a given node, multiple branches may grow out of a node. In the illustrated example, initial node 410 splits into three branches 402, 404, 406. The number of nodes and number of branches in the tree will vary depending upon the parameters to be analyzed. For example, in branch 402, the second node results in a split into branch 402a and 402b. Branch 404 splits at its second node into three branches 404a, 404b and 404c, then branch 404b splits at the third node into branches 404ba and 404bb. The tree structure reflects the hierarchical gating. The input data at each node is the result of gating from its parent node.

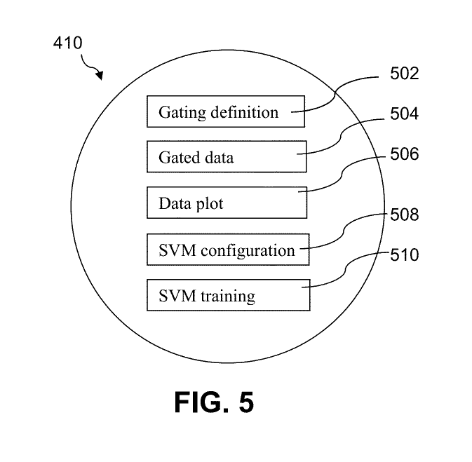

FIG. 5 shows the structure of each node 410 in the tree illustrated in FIG. 4. Each node includes a gating definition 502, a gated data set 504, a graphical plot of the data 506, an SVM configuration 508, and a trained SVM data set 510.

### EXAMPLE 2

### Sample Results for Standard Leukemia/Lymphoma Panel

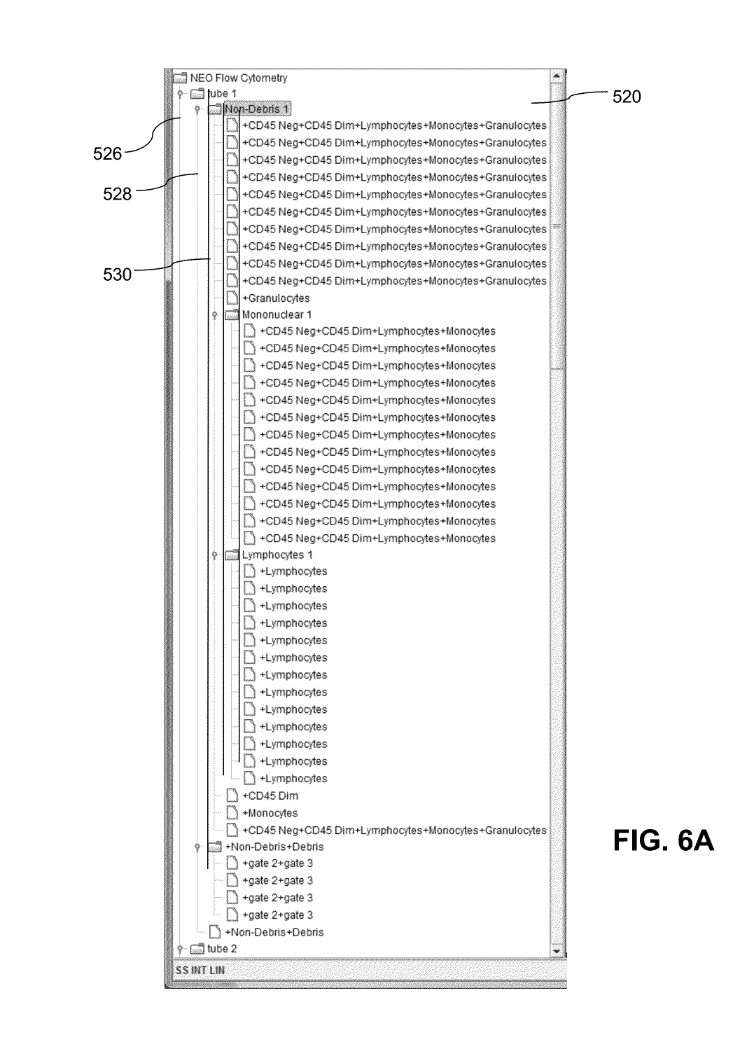

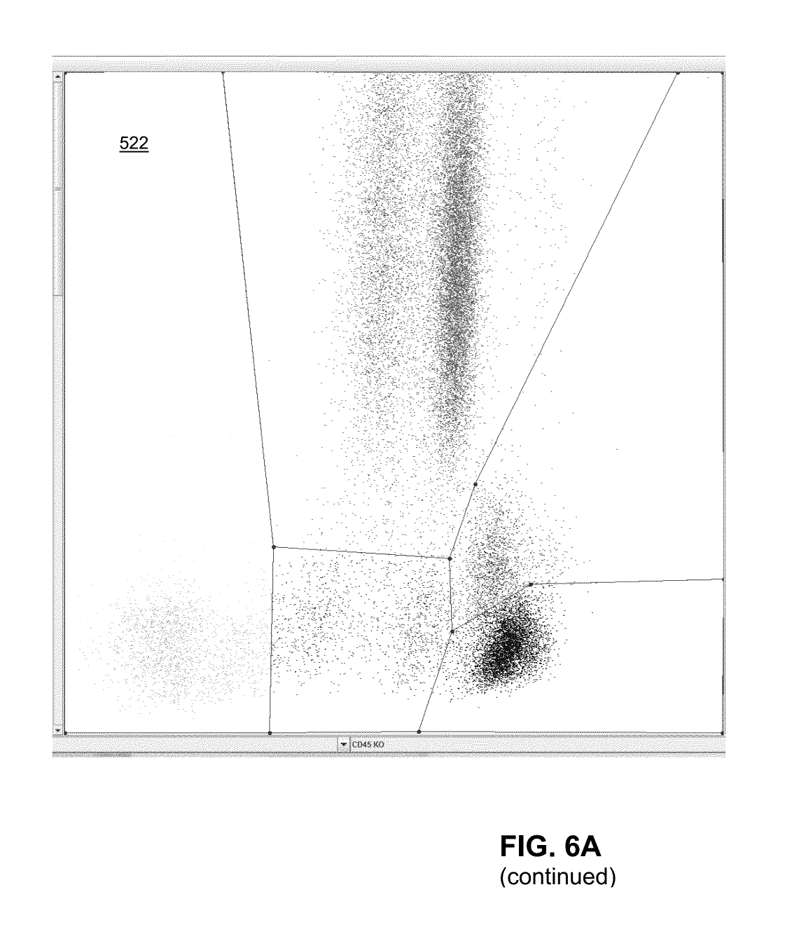

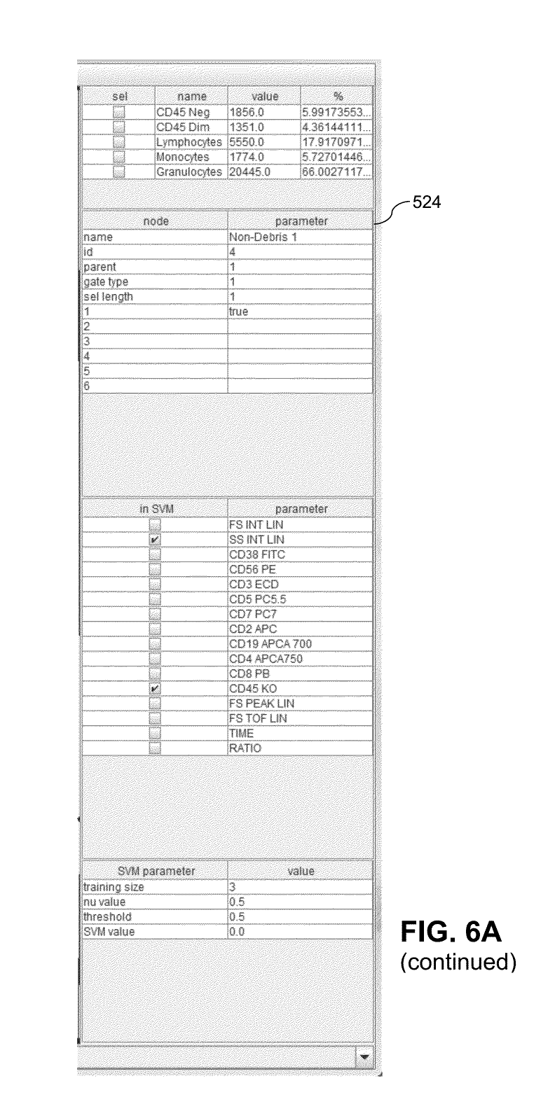

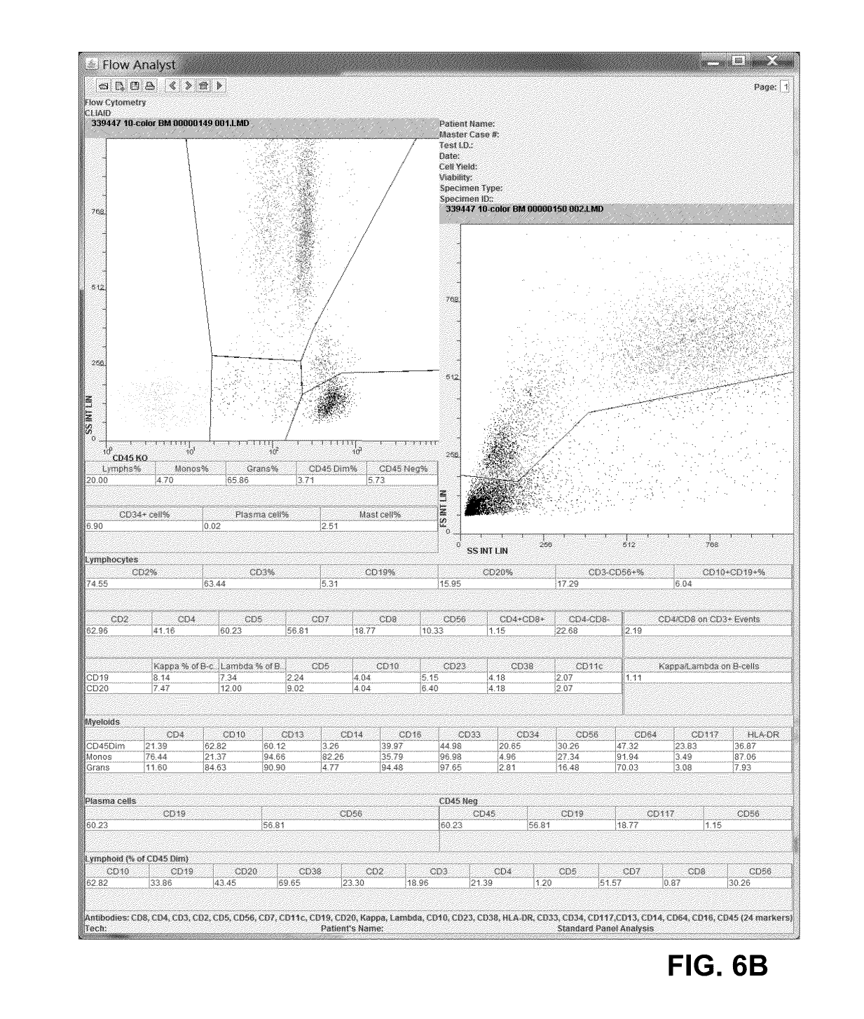

Exemplary results produced by the inventive system are shown in FIGS. 6A and 6B. The analysis software includes a function to read data files in the standard FCS format. It can also export the results in various formats. FIG. 6A is split over multiple pages to provide adequate resolution. In each case, the first page of the figure corresponds to the left panel 520 of the screenshot; the second page is the center panel 522, and the third page is the right panel 524. The left panel 520 displays files corresponding to the gated data. As illustrated, the first gating parameter 526 is the sample tube number (tube 1, tube 2, . . . , tube x). For example, this gating operation would correspond to the first node 410 in FIG. 4. The next gating 528 (subgating) is non-debris and non-debris+debris, which would be, e.g., the second node in branch 402a. The non-debris is then further subgated by mononuclear and lymphocytes. Following the prior example, this gating 530 and analysis would occur in the third node in branch 402a.

The center panel 522 of FIG. 6A displays the flow cytometry data marked with the different subpopulations as determined by the parameters. In this case, the marker is CD45 KO as detected by SS INT LIN (side scatter intensity, linear). The right panel 524 of FIG. 6A provides a table listing the various parameters used in the gating and SVM analysis. As illustrated, parameters SS INT LIN and CD45 KO are checked under the heading “in SVM”, indicating that SVM analysis was performed based on these parameters providing the data forp and q in the distributional kernel in Equation (3) above.

The bottom of the screenshot of FIG. 6B provides an exemplary list of possible markers (antibodies) within the screening panel for the illustrated test. Here, 24 markers are indicated: CD2, CD3, CD4, CD5, CD7, CD8, CD10, CD11c, CD13, CD14, CD16, CD19, CD20, CD23, CD33, CD34, CD38, CD45, CD56, CD64, CD 117, HLA-DR, kappa, and lambda, which represents a standard leukemia/lymphoma panel, which is useful to assist in diagnosis of leukemia and lymphoma, and for post-treatment follow-up. While not all of the markers may be represented in this screenshot, FIG. 6B illustrates a sample screenshot of the results of the analysis, including two 2D flow cytometry plots for CD45 KO versus SS INT LIN (upper left quadrant) and SS INT LIN versus FS INT LIN (upper right quadrant.) In addition, as will be readily apparent to those in the art, selection of appropriate markers will depend on abnormality known or suspected to be present. For example, an extended leukemia/lymphoma panel may add CD11b, CD41, CD138, CD235a and FMC-7 to the listed markers for a standard panel. Smaller panels of selected markers may be used for prognostics and therapy monitoring. Regardless of which markers are used, the same basic procedures will be followed to extract information for relevant subpopulations from the large volume of data.

One part of the software system facilitates the design of the gating structure, configuration and training of SVM, and the setting of default values. Gating is defined as any process that selects a subpopulation of cells based on specific criteria on observed parameters. Gating is an effective technique for reducing the complexity of the data and focusing the analysis on a specific subpopulation of the data. However, in order to address all aspects of the analysis, there will typically be a large number of gates and the gating structure itself may be complex.

The hierarchical structure of this system facilitates flexible and convenient definitions of very general types of gating.

At each node, in step 502 a 2D gating is defined based on a selection of any two parameters. A 2D plot 506 is the basis for defining the gating.

The gated data 504 at a node is the cumulative result of the chain of gating at the series of nodes preceding the current node. Because each node defines a 2D gating with any combination of parameters, the hierarchical scheme allows for the definition of virtually any gating configuration.

For example, a gating on FS (forward scatter) and SS (side scatter) can filter out debris. On the Non-debris, another gating on FS and the CD45 marker can be defined to separate five subpopulations: CD45-Dim (diminished marker), Monocytes, CD45-Negative (negative marker), Granulocytes, and Lymphocytes. The mononuclear cells can be further gated to feed new nodes.

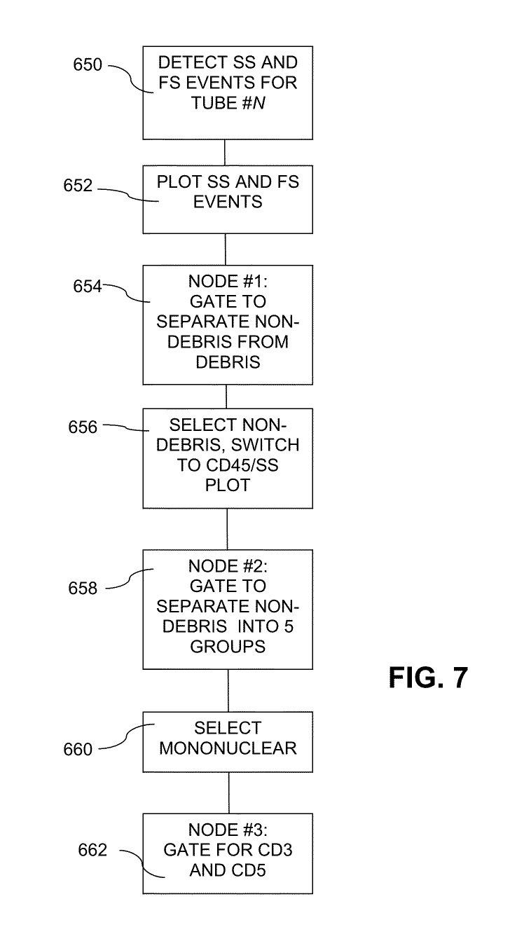

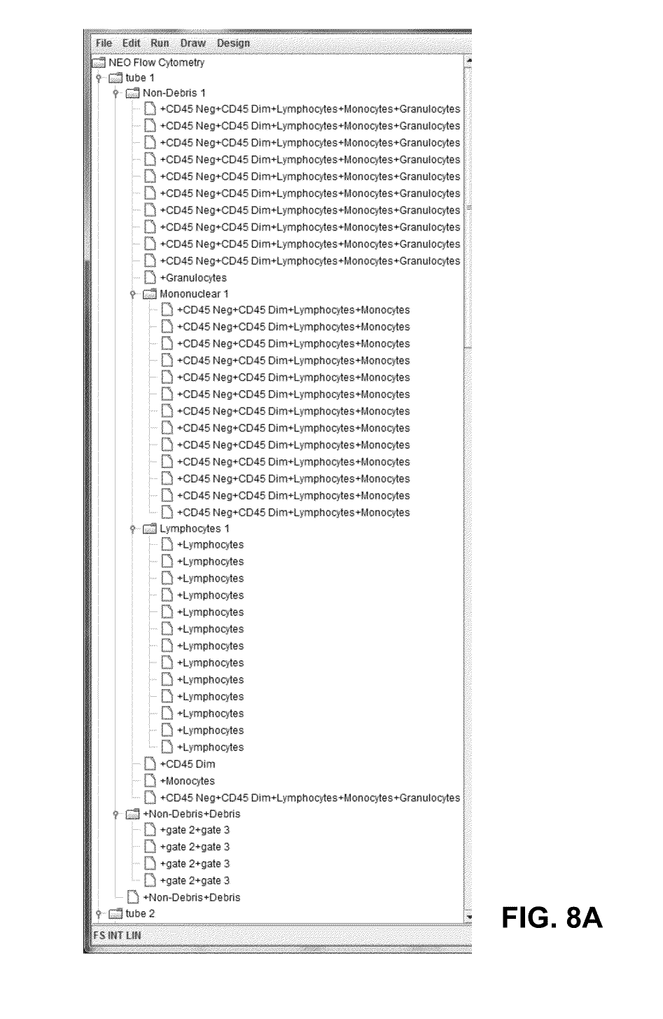

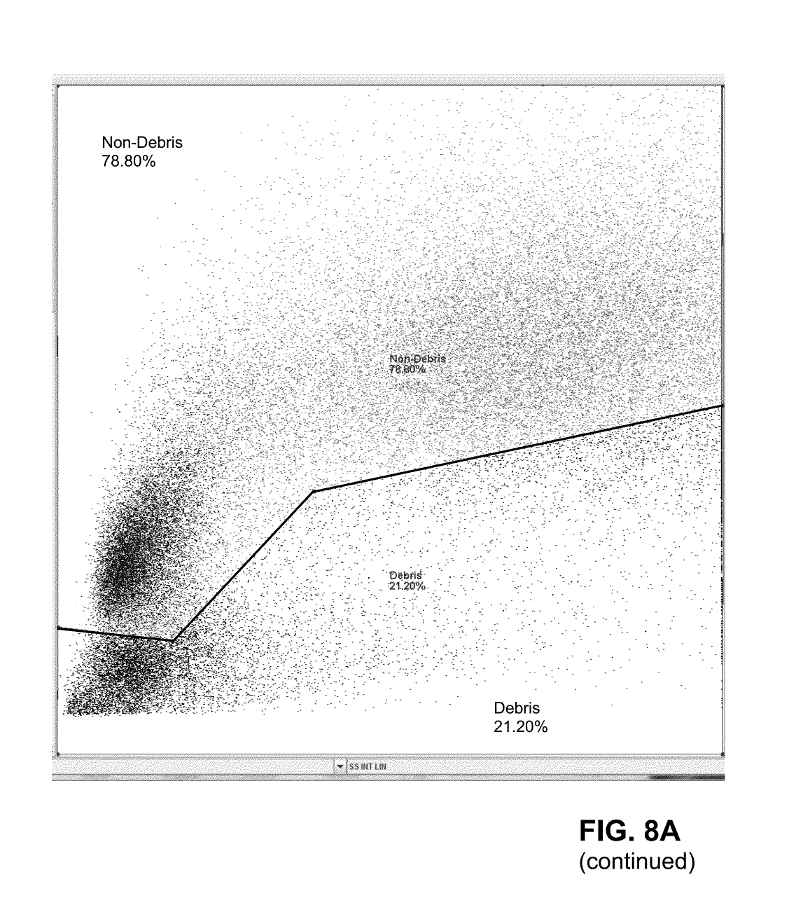

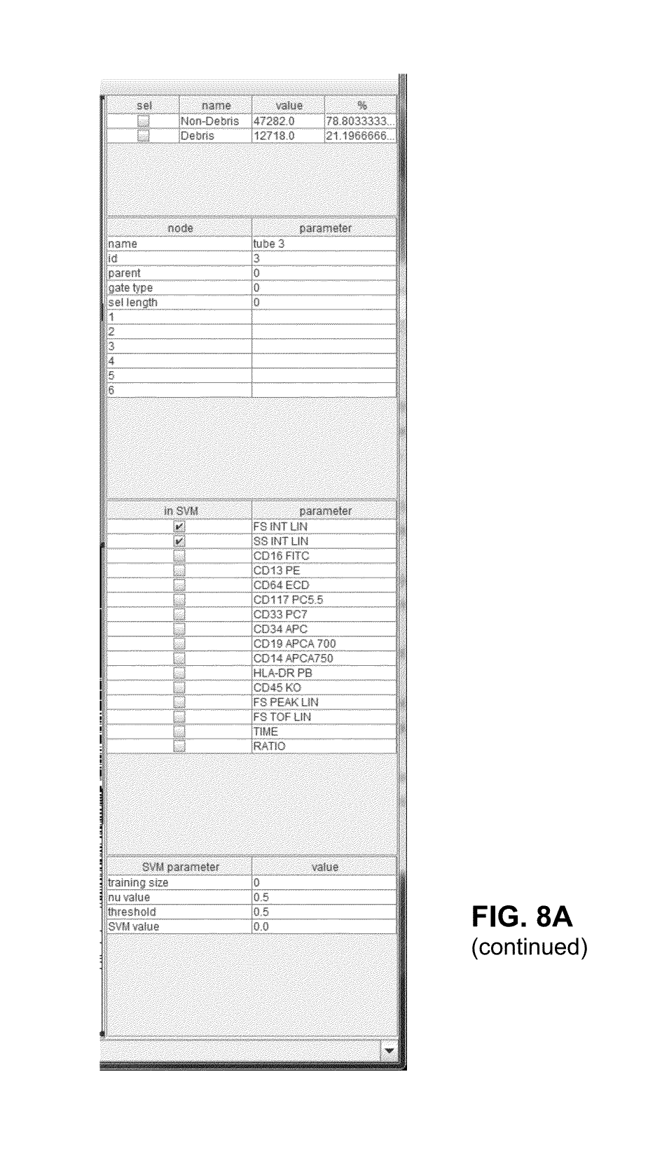

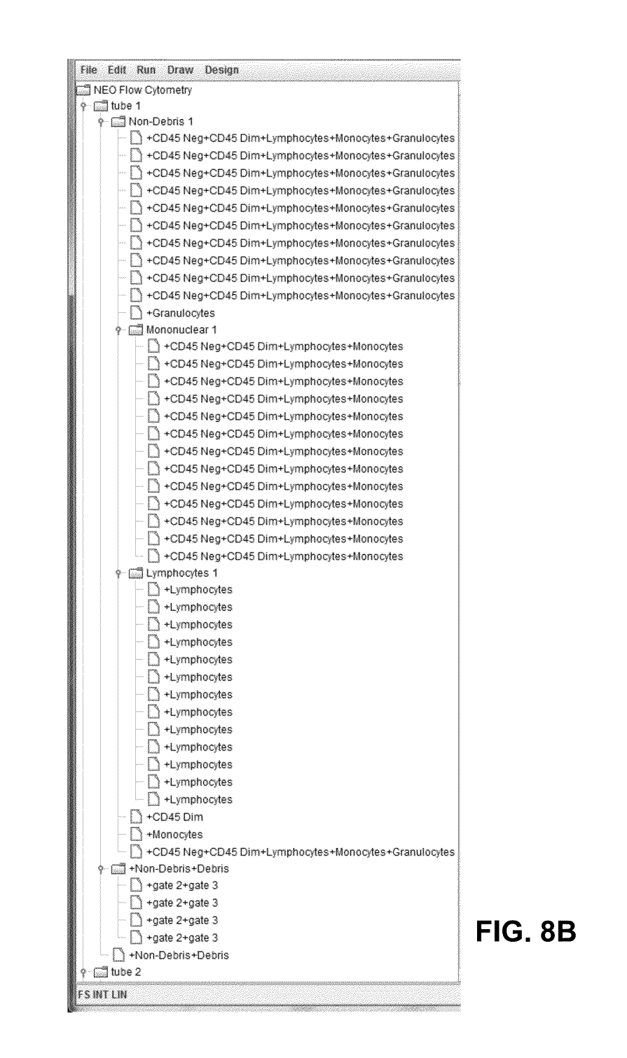

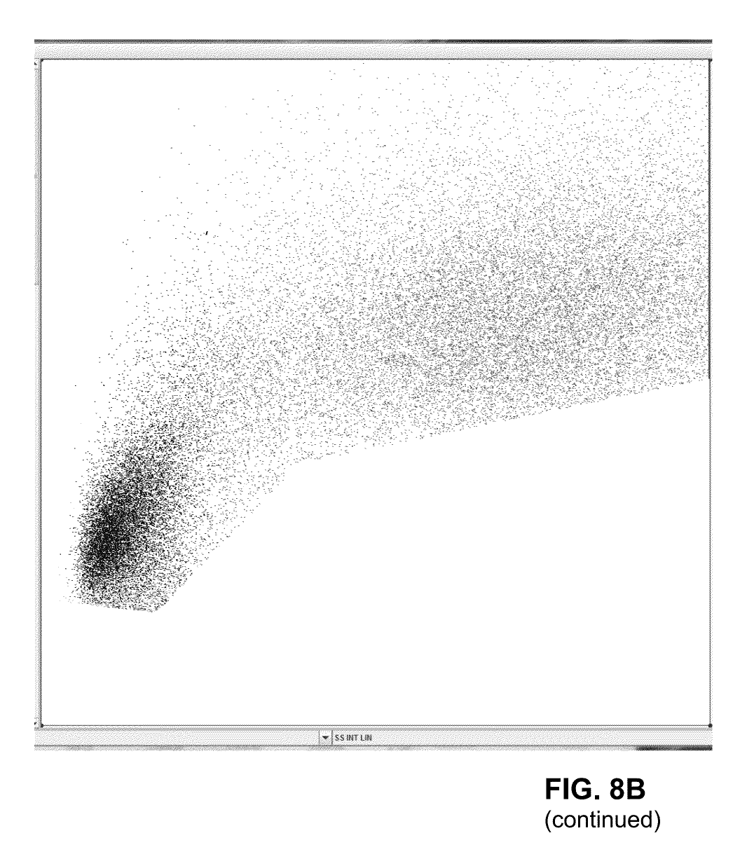

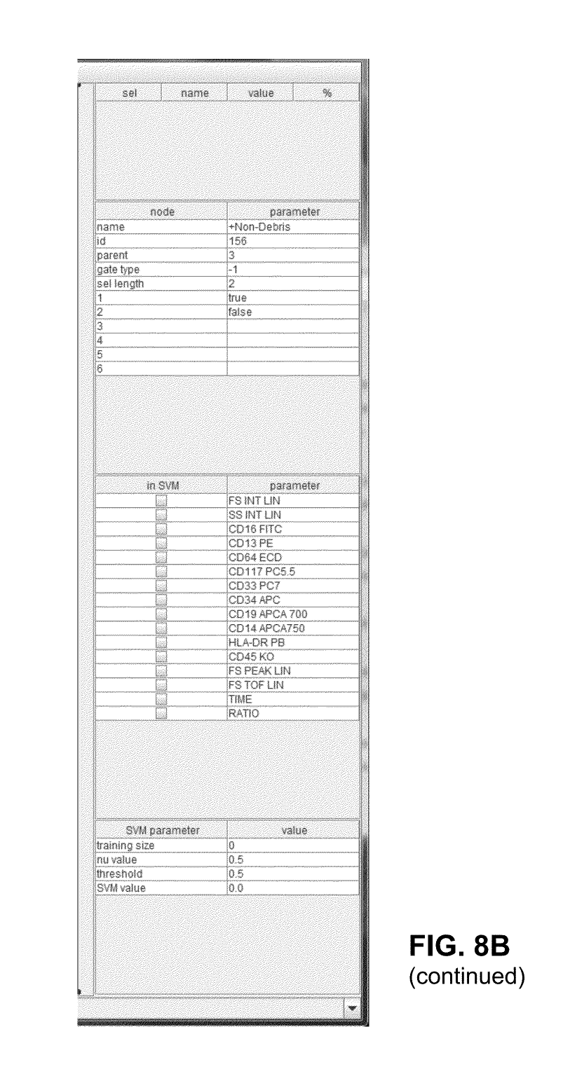

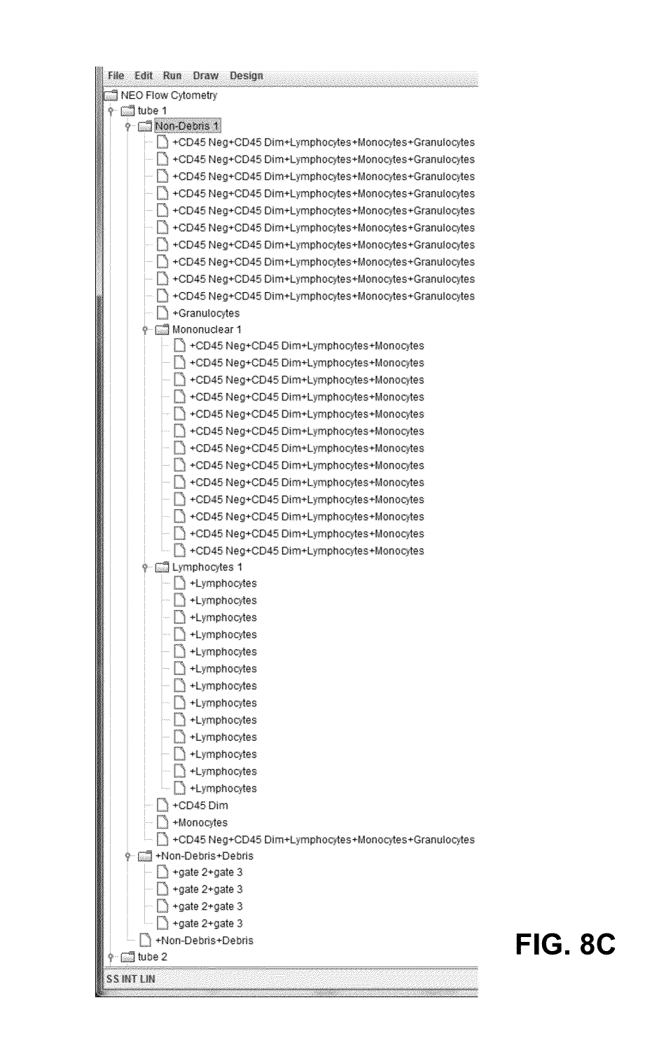

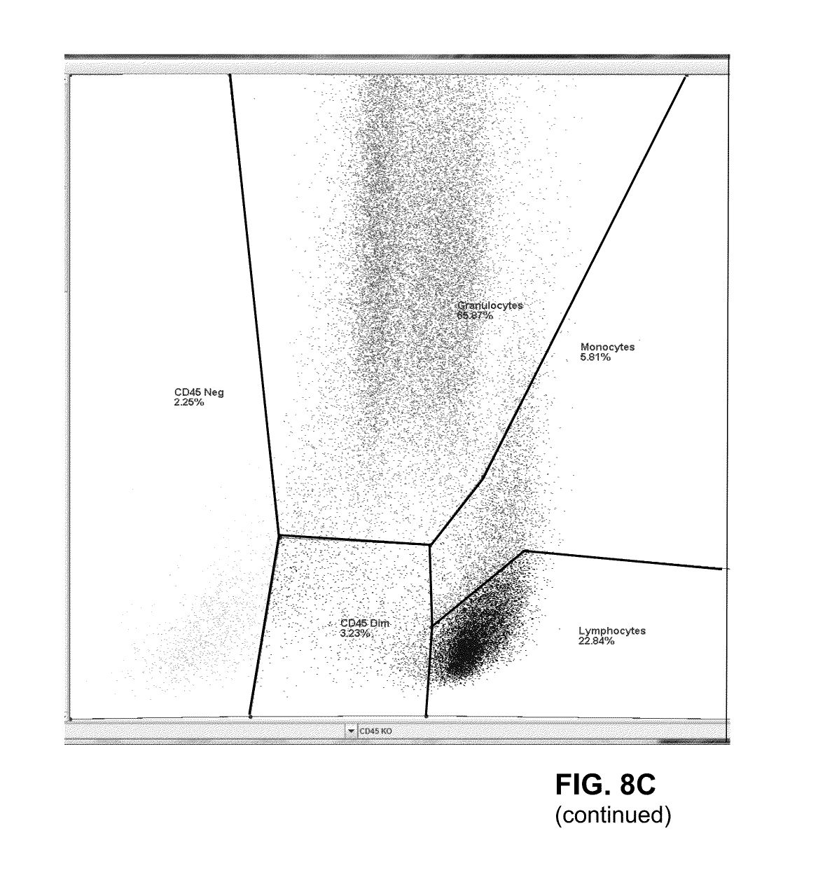

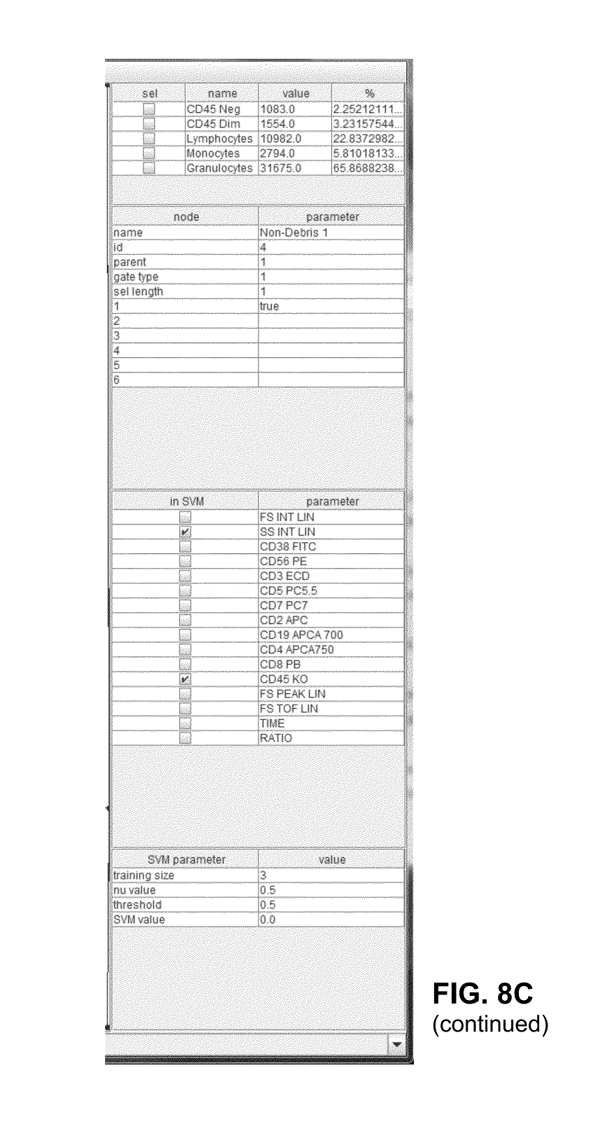

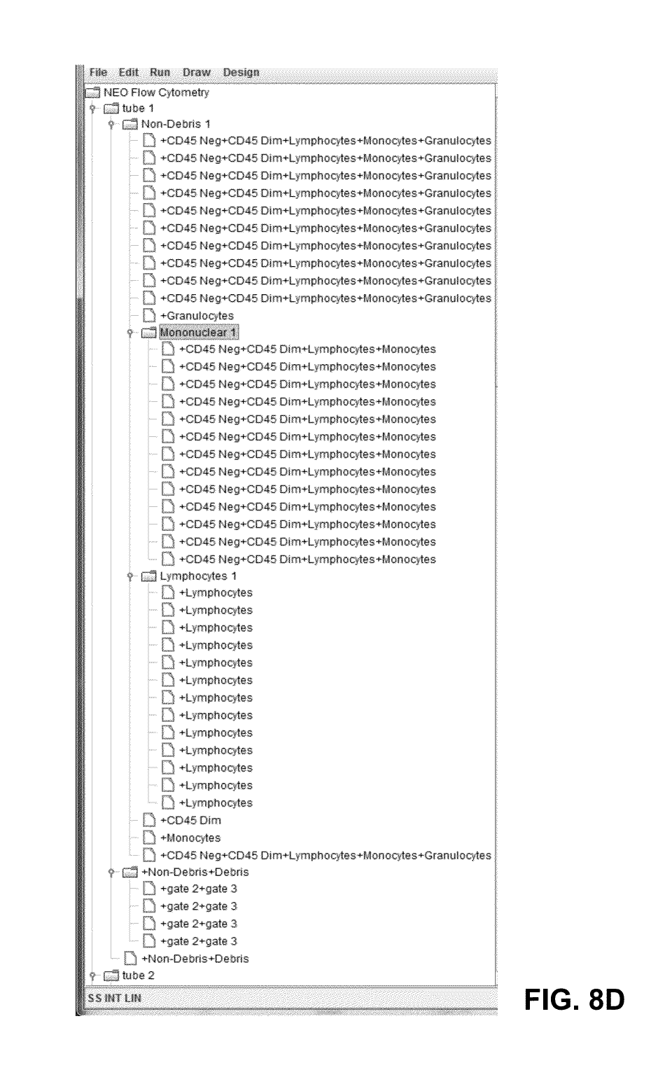

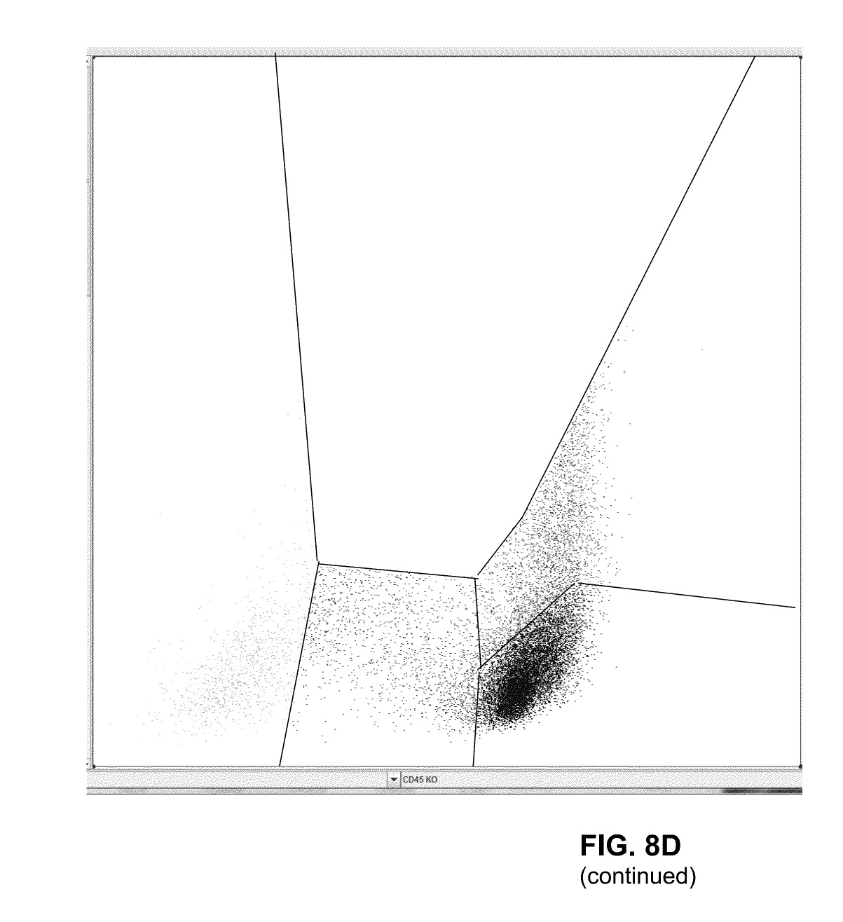

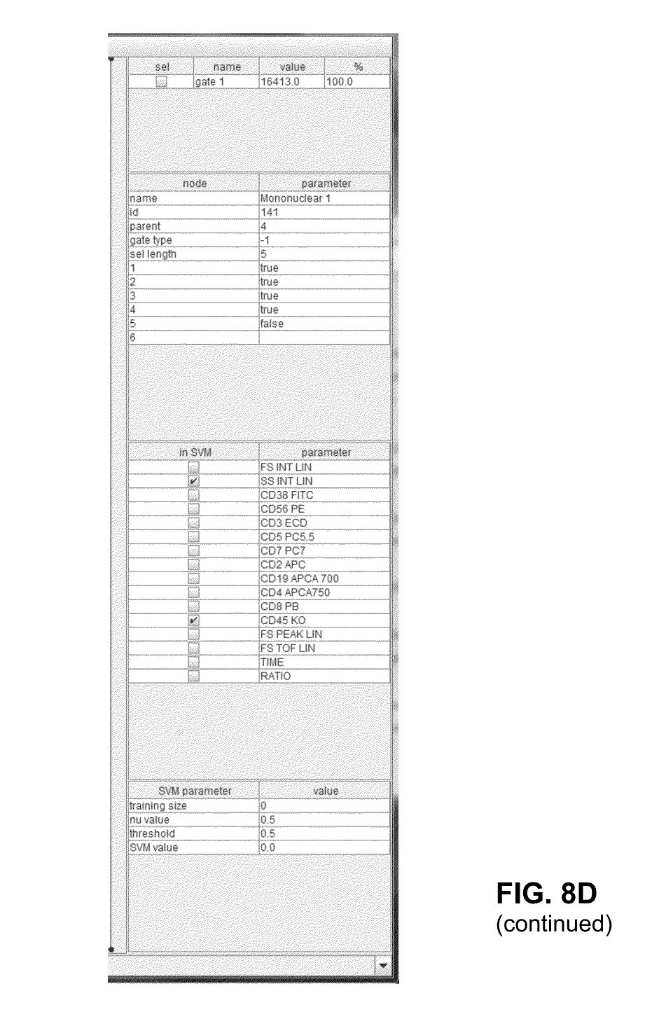

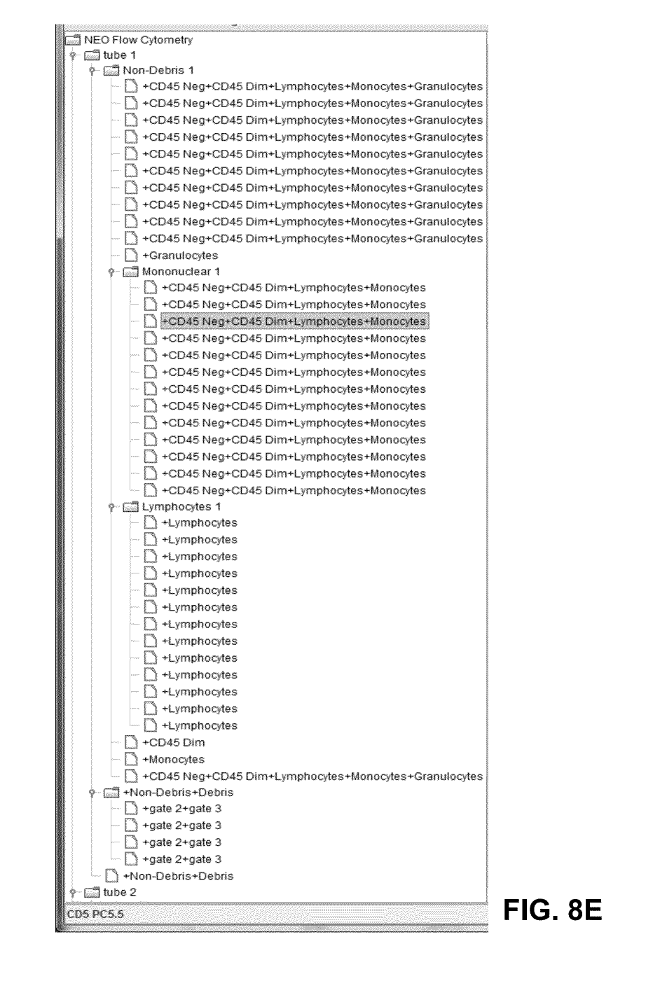

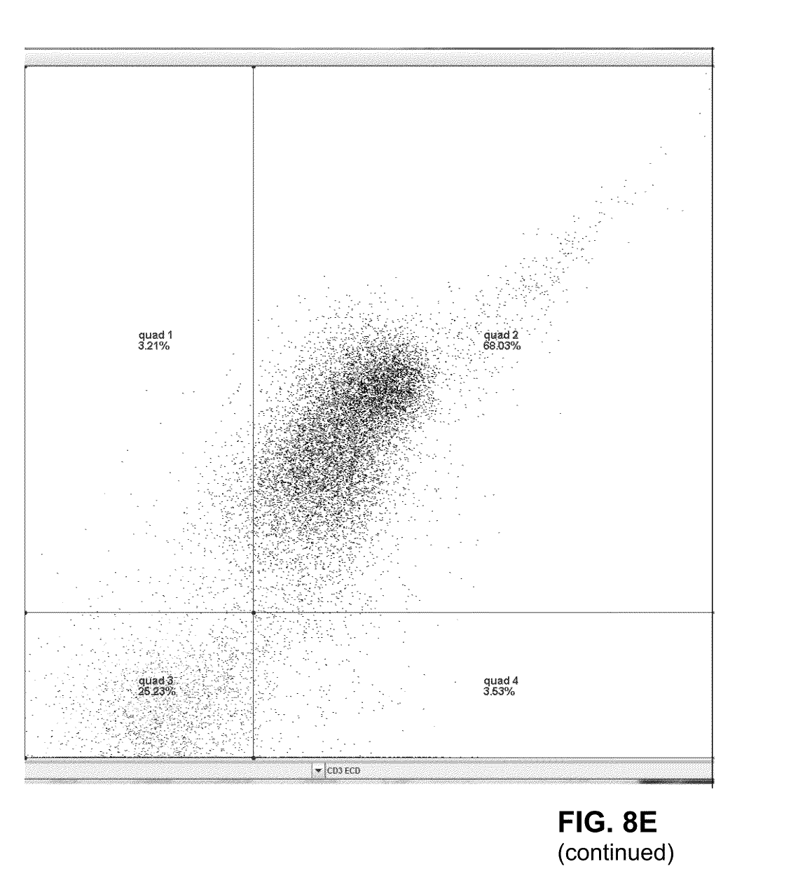

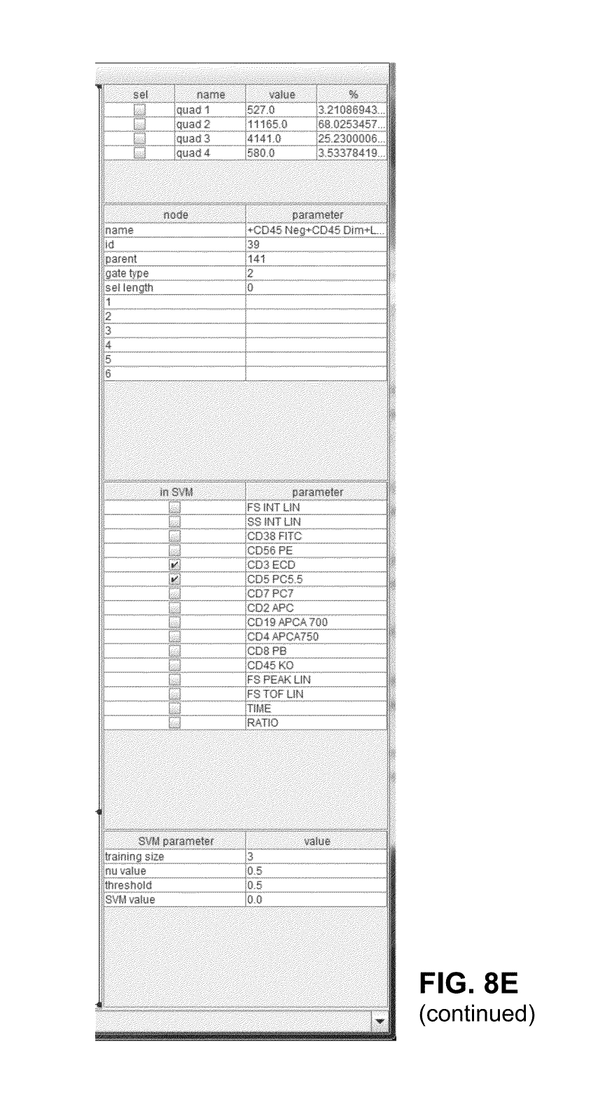

FIG. 7 provides a flow diagram that represents a possible gating sequence in one branch of a tree 400 such as that shown in FIG. 4. The illustrated branch includes three nodes, each of which has the structure of the node 410 shown in FIG. 5, including an SVM processing step to separate the event data into the selected populations. For example, in step 650, the side scatter (SS) and forward scatter (FS) events are detected, then plotted in step 652, producing a 2D image with a data distribution. Using the plot of SS/FS data, in step 654, Node #1 executes a gating operation to separate the non-debris from the debris. This separation is illustrated in FIG. 8A in which the plot in the center panel of the screenshot shows a line between non-debris and debris. In step 656, non-debris is selected, then analysis is directed to the plot containing the non-debris data evaluated for CD45 and SS INT LIN. This plot is shown in the center panel of FIG. 8B. In step 658, Node #2 separates the non-debris data into 5 population groups: granulocytes, monocytes, lymphocytes, CD45-Dim and CD45-Neg. The plot in the center panel of FIG. 8C shows the groupings that were identified by plotting SS INT LIN data for the CD45 KO marker. (Note the checked parameters under “in SVM” in the right panel of FIG. 8C: “SS INT LIN” and “CD45 KO”.) For the next step 660, the granulocyte data are excluded and the remaining mononuclear data, plotted in the center panel of FIG. 8D, are gated in Node #3 (step 662) to separate CD3 and CD5 cell surface receptors. The resulting plot is provided in FIG. 8E, which shows the flow cytometry data subgated into quadrants based on % positive on X and Y; % negative on X and Y; % double positive; and % double negative. This breakdown is generated by SVM analysis of the data in the plot using a distributional kernel. The upper portion of right panel of FIG. 8E provides the numerical values for the distributional analysis.

This process would be repeated for each tube of a patient sample. Additional branches with different gating definitions could be run in parallel, for example, a branch could diverge from node #1 to perform a different set of separations. An optional final step would be to combine the results of each tree branch to generate a diagnostic conclusion taking into consideration the results achieved at the end of each branch. In the preferred embodiment, this final analytical step would be performed by a support vector machine, generating a diagnostic score, a binary, e.g., positive or negative, result, a probability, a prognostic prediction, or other appropriate indicator of the subject's diagnosis or prognosis.

The following is an exemplary algorithm for automatic gate detection according an embodiment of the invention:

The system automatically detects gate definitions from user specified points and lines. A pseudo code for the algorithm is given below:
for each vertex v with outdegree>0
   add v to gate
   find first edge (v,u) in counter-clockwise order
   remove (v,u)
   while u !=v
      v=u
      add v to gate
      find first egde (v,u) in counter-clockwise order remove (v, u)

In some situations, the gating may require some adjustments for individual cases. Because of the large number of gates involved in an analysis, this can be a tedious process.

The inventive system provides an automatic gating adjustment function based on clustering. The gates in flow cytometry data are usually associated with clusters of cells. Automated clustering of the actual data provides a natural way to make an appropriate adjustment to the default gating template.

A Gaussian mixture model (GMM) is a probability distribution that is a weighted sum of Gaussian distributions:

$$f ( x ) = {\sum }_{i = 1}^{m} {w}_{i} g ( x \vert {μ}_{i} , {\sum }_{i} )$$

$$g ( x \vert {μ}_{i} , {\sum }_{i} ) = \frac{1}{{( 2 π )}^{d / 2} {\vert {\sum }_{i}^{- 1} \vert}^{1 / 2}} {e}^{- \frac{1}{2} {( x - {μ}_{i} )}^{′} {\sum }_{i}^{- 1} ( x - {μ}_{i} )}$$

The parameters in the GMM can be determined by a learning algorithm known as Expectation-Maximization (EM) algorithm. In statistics, an expectation-maximization algorithm is an iterative method for finding maximum likelihood or maximum a posteriori (MAP) estimates of parameters in statistical models, where the model depends on unobserved latent variables.

The present system applies GMM to detect clusters in the flow data at a node. The cluster information is then used to make adjustment on gating templates. Users also have the option to manually adjust the gating.

After gating, the characteristics (parameters) of each subpopulation is captured for analysis. Each node in the gating tree has an associated SVM, which is defined on the gated data present at the node. The SVM associated with a specific subpopulation is trained to analyze the distribution patterns in the data for that subpopulation and to provide a quantitative assessment of normality/abnormality for the data in the subpopulation.

The SVM input is not limited to the 2D plot. Any combination of the parameters, as well as the gated populations at each node, can be used for SVM learning and subsequent SVM classification. The system may use different types of SVMs such as C-SVM, nu-SVM, and single-class-SVM.

Additional features of the software system includes functions to import data, make gating adjustments, perform SVM analysis, and present results graphically.

The distributed system of SVM based analysis nodes will provide a quantitative indication of abnormality on an entire case.

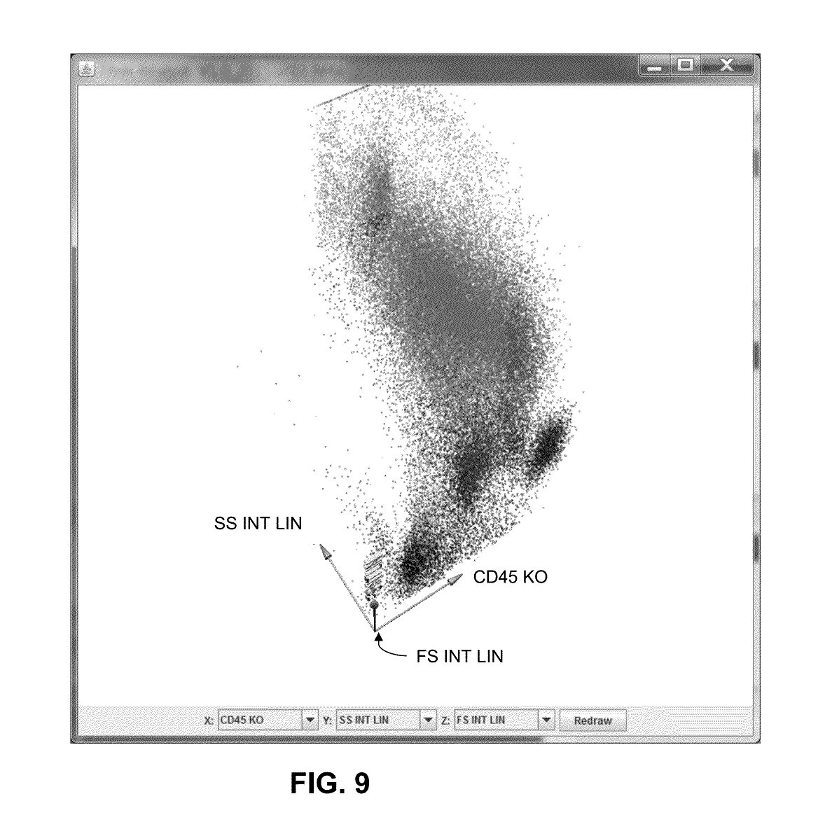

In an embodiment of the software system, different visualization methods for displaying data may be included. In addition to traditional 2D plots, 3D plots are available, as illustrated in FIG. 9, where the X axis is CD45 KO (CD45-Krome Orange dye), the Y axis is SS INT LIN (side scatter intensity, linear) and the Z axis is FS INT LIN (forward scatter intensity, linear.) Any three parameters may be selected for the 3D plot. A user may interactively move, rotate, and scale the 3D plot. The 3D function provides a significantly enhanced representation of the structure of the flow data.

### EXAMPLE 3

### Highlighting of Abnormal Results

A key goal of the automated flow cytometry analysis system is to allow laboratory technicians to more readily identify cases requiring pathologist review. This is achieved in part by displaying abnormal plots and values using a visually-distinguishable feature, such as using a specific color font or highlighting, e.g., red, in a display of the analysis results.

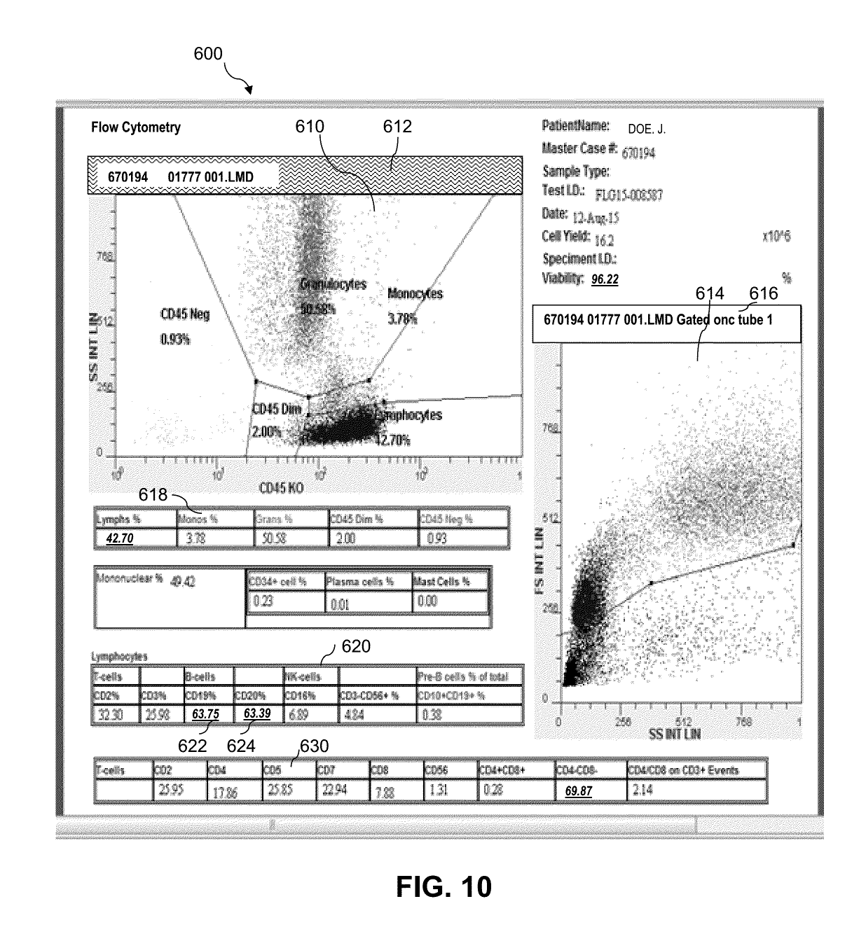

FIG. 10 provides an example of a screen display 600 on a monitor of a user workstation. In this example, patient samples were subjected to flow cytometry analysis. In one part of the analysis, a plot 610 is generated to illustrate the subpopulations identified during gating on SS and CD 45 to separate subpopulations and the relative percentages of CD45 Negative (0.93%), granulocytes (50.58%), monocytes (3.78%) CD45-Dim (2.00%) and lymphocytes (42.70%), which are plotted with X axis of CD45 KO (CD45-Krome Orange dye), and the Y axis of SS INT LIN. In this example, the lymphocyte count exceeds the normal range of 20-40%, so the plot is highlighted to signal to the user that an abnormal value was measured. In a color display, the upper bar 612 on the plot might be red, or the entire plot might be outlined in red. For purposes of illustration, the upper bar 612 of the plot is highlighted with wavy lines.

Plot 614 illustrates the results of gating on FS INT LIN and SS INT LIN. Because the results of this gating did not exhibit abnormal results, the plot is not highlighted, as indicated by the clear upper bar 616 of the plot. Table 618 in the display provides the numerical results for each subpopulation. Again, because of the abnormal value for lymphocytes, the displayed value is highlighted to indicate to the user that an abnormal value was measured. On a color display, the number “42.70” might appear in red or some other color to distinguish it from the other values. For purposes of illustration, the value is shown underlined, bolded and in italics. Analysis of the subpopulations shown in plot 610 included further gating of the lymphocytes, the numerical results of which are displayed in table 620 of the display. As described above, each sub-subpopulation is analyzed by a separate node that is branched off from the node that performed the initial gating and analysis. In the example, lymphocytes are gated into subpopulations of T-cells (CD2, CD3), B-cells (CD19, CD20), NK-cells (CD16, (CD3-CD56)), and pre-B cells (CD10+CD19). The resulting numerical results are entered into table 620, which the abnormal results relating to B-cells indicated by highlighting the values 622 and 624 in the display. In table 630 of the display, another abnormal value, for CD4-CD8, is highlighted.

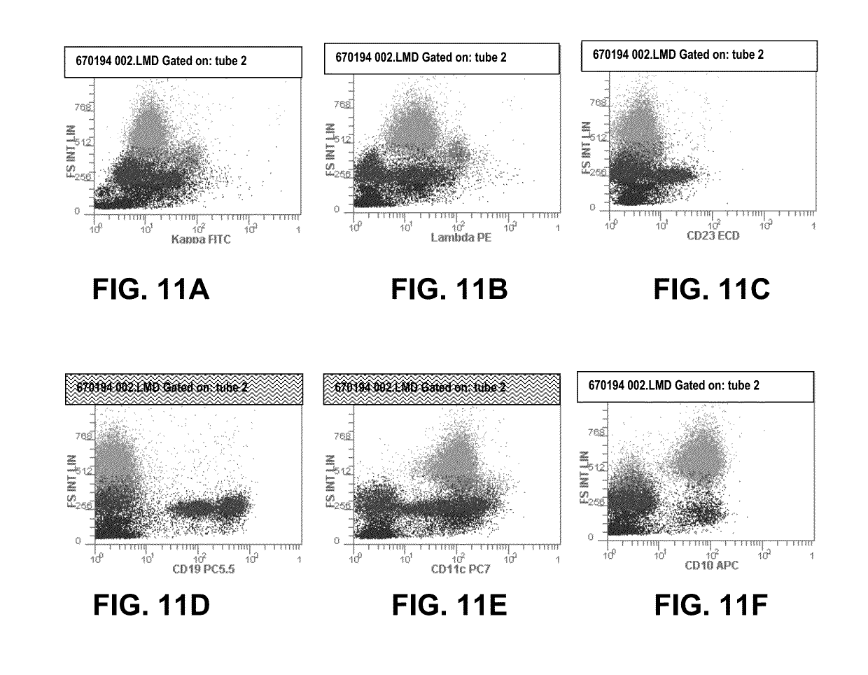

FIGS. 11A-11F provide further illustration of the display feature that provides an indication to the user of the presence of abnormal results following analysis of the second sample from the patient. FIG. 11A plots Kappa FITC against FS INT LIN. The clear upper bar indicates normal results. Similarly, the results plotted in FIG. 11B (Lambda PE vs. FS INT LIN) and FIG. 11C (CD23 ECD vs. FS INT LIN) are normal. However, FIG. 11D (CD19 PC5.5 vs. FS INT LIN) and FIG. 11E (CD11c PC7 vs. FS INT LIN) are abnormal, as indicated by the highlighting in the bar above the plot.) FIG. 11E (CD10 APC vs. FS INT LIN) indicates normal results for this parameter.

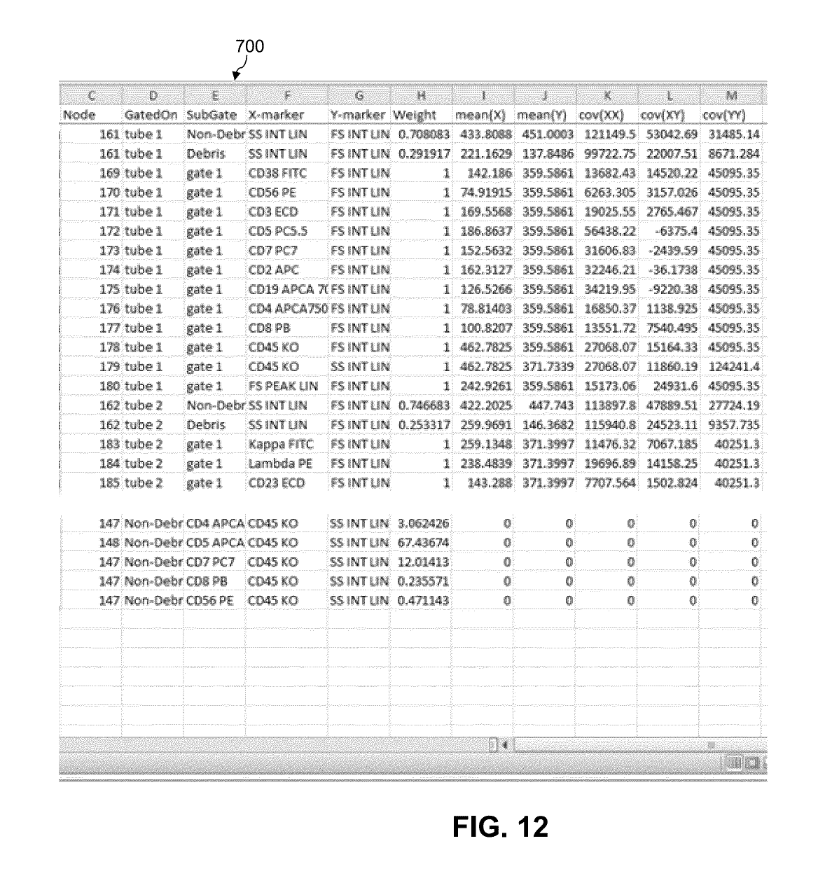

FIG. 12 illustrates an exemplary spreadsheet 700 for capturing and quantifying various parameters of each subpopulation. The spreadsheet listing includes the node number (column C), the gated parameter, e.g., tube number, non-debris (column D), subgate characteristics, e.g., non-debris, debris, gate 1, CD4 APCA, etc. (column E). Column F corresponds to the X-axis parameter, while column G provides the Y-axis parameter. Columns H through M provide the weight, X- and Y-means, and covariance of each population, all of which are used in conjunction with the distributional kernel for SVM analysis.

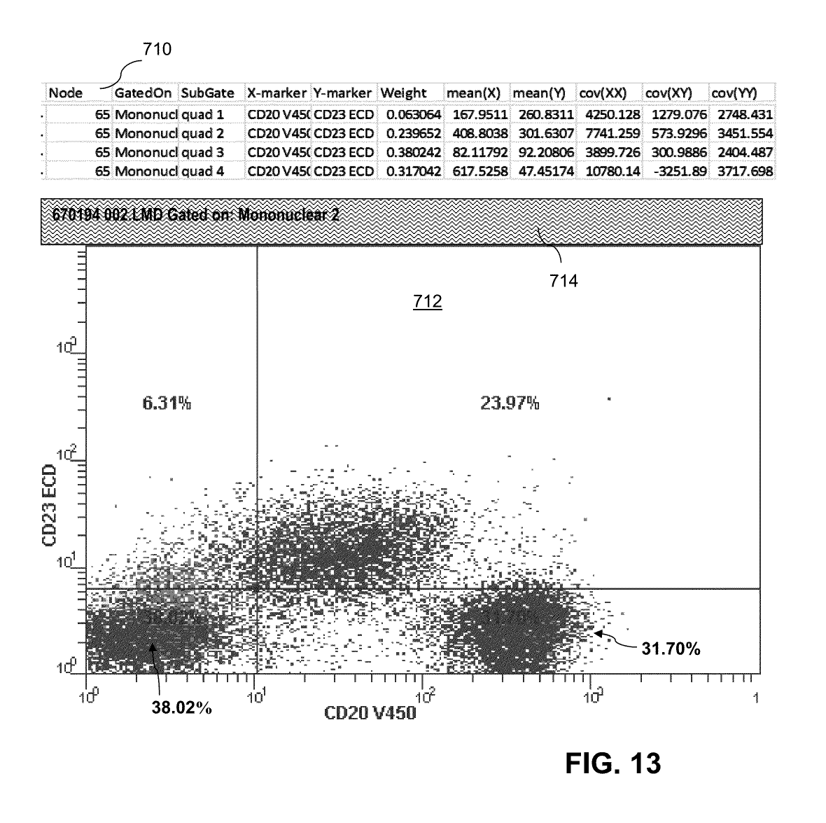

FIG. 13 provides additional detail of the process involved in flow cytometry data analysis according to an embodiment of the invention. Plot 712 shows the plotted flow cytometry data gated on Mononuclear 2 using the X- and Y-markers, CD20 V450 and CD23 ECD, respectively. Spreadsheet data 710 for the node used to perform this analysis (sample node number 65 (from column C of FIG. 12)) gated on mononuclear 2 then subgated into 4 quadrants: % positive on X and Y; % negative on X and Y; % double positive; and % double negative. The subgating into quadrants provides the weights corresponding to counts (percentages) of the cells falling into the different quadrants. The calculated means for each marker are provided in the spreadsheet as are the distributions (covariance) for each population. Because these results are outside of normal values, upper band 714 of plot 712 is highlighted to indicate to the user that abnormal results have been identified.

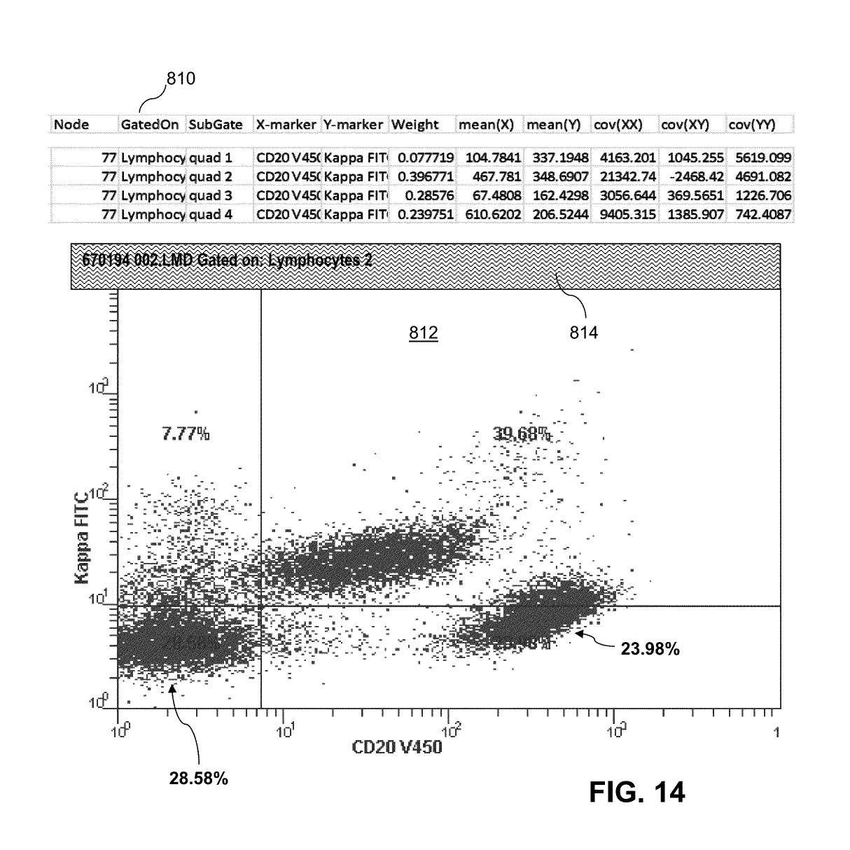

FIG. 14 provides another example of the process involved in flow cytometry data analysis according to an embodiment of the invention. Plot 812 shows the flow cytometry data gated on Lymphocytes 2 using X-marker CD20 V450 and Y-marker Kappa FITC, Spreadsheet data 810 for sample node number 77 (from column C of FIG. 12) is gated and subgated into 4 quadrants: % positive on X and Y; % negative on X and Y; % double positive; and % double negative. The calculated means for each marker are provided in the spreadsheet as are the distributions (covariance) for each population. Because these results are outside of normal values, upper band 814 is highlighted to indicate to the user that abnormal results have been identified.

As will be apparent from the foregoing examples and accompanying figures, any combination of parameters may be used to automatically analyze flow cytometry data. Each parameter is separately

In some embodiments, the system is configured to maintain a database to collect data from analyzed cases. (See, e.g., database 130 in FIG. 1.) All relevant data, the reported statistical values, and the features for SVM evaluation are saved in this database. The general consensus among the flow cytometry experts is that there is more useful information in the volumes of flow cytometry data than what is currently known. This database will help facilitate future research in discovery of new patterns and diagnostic information in flow data.

The software preferably includes user instructions with reminders to save the data at the conclusion of an analysis. For multiple analyses of the same case, options are available to overwrite the old data or to save both versions of the data.

To ensure the integrity and security of the software system, a preferred embodiment of the software system includes a real-time authentication function. An authentication server is established to process the authentication requests. The client software communicates with the server over the Internet through a secure protocol.

In some embodiments, the analysis may be performed on a client machine that is remote from the laboratory in which the flow cytometry instrumentation resides. For example, the raw data may be processed and transmitted via a network to one or more remote locations. The flow cytometry analysis software running on a client machine will be required to complete authentication before it is permitted to begin normal operations.

In one embodiment, the client will transmit an encrypted message to the server containing the following fields:

Nonce

Timestamp

Account

Usage

Software signature

Hardware signature

Upon receiving the authentication request, the server will verify each of the fields. If the authentication is successful, the server will send an encrypted authentication message that matches the request back to the client. This protocol is designed to prevent a “replay attack”. The use of nonce and timestamp will ensure that the messages are unique even for the same client.

The authentication function will help provide assurance that the software has not been altered maliciously, the software is properly licensed, the system is configured properly in a conforming environment, and all analyzed cases are accounted for.

Flow cytometric immunophenotyping is an accurate and highly sensitive method for detection of quantitative and qualitative abnormalities in hematopoietic cells even when combined morphology and cytogenetics were non-diagnostic. The automated flow cytometry data analysis system disclosed herein provides the ability to automatically analyze the huge volumes of data generated during flow cytometry measurement, enhancing the accuracy, repeatability and versatility of flow cytometric methods. The capability provided by the methods disclosed herein enhances not only the diagnostic value of flow cytometry but also expands research applications of the technique by enabling collection and analysis of massive amounts of flow cytometry data from many subjects for data mining and pattern recognition that go far beyond current limited approaches.

1. A method for analysis and classification of flow cytometry data, wherein the flow cytometry data comprises a plurality of features that describe the data, the method comprising:
downloading an input dataset comprising flow cytometry events for a population of cells into a computer system comprising a processor and a storage device, wherein the processor is programmed to execute at least one support vector machine and performs the steps of:
defining a hierarchical structure of analytical elements, each analytical element corresponding to a different gating definition, wherein each analytical element applies a gating algorithm to classify a subpopulation of cells according to predetermined criteria on a combination of parameters, wherein the classification is performed using a support vector machine with a distributional kernel; and
generating an output display at a display device with an identification of a flow cytometry data classification.

2. The method of claim 1, further comprising selecting a subpopulation of cells and analyzing the selected subpopulation of cells using a different analytical element that applies a different gating algorithm to further classify the subpopulation.

3. The method of claim 1, wherein the distributional kernel comprises a Bhattacharya affinity having the form:
k(p,q)=e^{-ρ(p,q)}=\sqrt{|(Σ₁+Σ₂)/2|\sqrt{|Σ₁|·|₂|}}⁻¹ exp{−1/8(M₂−M₁)^{T}[Σ₁+Σ₂/2]⁻¹(M₂−M₁)},
where p and q are input data points, M is the mean of a normal distribution and Σ is a covariance matrix.

4. The method of claim 1, wherein the hierarchical structure comprises a tree having a plurality of branches, and further comprising a conclusion analysis step for combining results produced by each branch into a diagnostic classification.

5. The method of claim 4, wherein the diagnostic classification comprises either presence or absence of a disease.

6. The method of claim 1, wherein the different gating definition is selected from the group consisting of sample tube identity, debris vs. non-debris, granulocytes, monocytes, lymphocytes, negative marker intensity and diminished marker intensity.

7. The method of claim 1, wherein generating an output display comprises highlighting abnormal results to facilitate visual detection by a user.

8. A method for automatically analyzing flow cytometry data comprising:
detecting side scatter and forward scatter events for a sample comprising a plurality of cells;
generating a plurality of plots of the side scatter and forward scatter events in two- or three-dimensions, the plurality of plots comprising flow cytometry data;
processing the plurality of plots using a hierarchical structure of analytical elements, each analytical element corresponding to a different gating definition, wherein each analytical element applies a gating algorithm to classify a subpopulation of cells according to predetermined criteria on a combination of parameters, wherein the classification is performed using a distributional kernel; and
generating an output at a display device with an identification of one or more flow cytometry data classifications.

9. The method of claim 8, further comprising selecting a subpopulation of cells and analyzing the selected subpopulation of cells using a different analytical element that applies a different gating algorithm to further classify the subpopulation.

10. The method of claim 8, wherein the distributional kernel comprises a Bhattacharya affinity having the form:
$$k ( p , q ) = {e}^{- ρ ( p , q )} = {\sqrt{\frac{\vert ( {\sum }_{1} + {\sum }_{2} ) \text{/} 2 \vert}{\sqrt{\vert {\sum }_{1} \vert \cdot \vert {\sum }_{2} \vert}}}}^{- 1} exp \{ - \frac{1}{8} {{( {M}_{2} - {M}_{1} )}^{T} [ \frac{{\sum }_{1} + {\sum }_{2}}{2} ]}^{- 1} ( {M}_{2} - {M}_{1} ) \} ,$$
where p and q are input data points, M is the mean of a normal distribution and Σ is a covariance matrix.

11. The method of claim 8, wherein the hierarchical structure comprises a tree having a plurality of branches, and further comprising a conclusion analysis step for combining results produced by each branch into a diagnostic classification.

12. The method of claim 11, wherein the diagnostic classification comprises either presence or absence of a disease.

13. The method of claim 8, wherein the different gating definition is selected from the group consisting of sample tube identity, debris vs. non-debris, granulocytes, monocytes, lymphocytes, negative marker intensity and diminished marker intensity.

14. The method of claim 8, wherein generating an output display comprises highlighting abnormal results to facilitate visual detection by a user.

15. A system for automated analysis of flow cytometry data, the system comprising:
a computer processor in communication with a memory having stored therein flow cytometry data comprising a plurality of assays performed on a plurality of samples comprising cells, the flow cytometry data comprising side scatter and forward scatter events; and
a computer-program product embodied in a non-transitory computer readable medium, the computer-program product comprising instructions for causing the computer processor to:
receive the flow cytometry data;
generate a plurality of plots of the side scatter and forward scatter events in two- or three-dimensions;
process the plurality of plots using a hierarchical structure of analytical elements, each analytical element corresponding to a different gating definition, wherein each analytical element applies a gating algorithm to classify a subpopulation of cells within the samples according to predetermined criteria on a combination of parameters, wherein the classification is performed using a distributional kernel; and
generate an output at a display device with an identification of one or more flow cytometry data classifications of the cells.

16. The system of claim 15, wherein the computer-program product further comprises instructions for causing the computer processor to select a subpopulation of cells and analyze the selected subpopulation of cells using a different analytical element that applies a different gating algorithm to further classify the subpopulation.

17. The system of claim 15, wherein the distributional kernel comprises a Bhattacharya affinity having the form:
$$k ( p , q ) = {e}^{- ρ ( p , q )} = {\sqrt{\frac{\vert ( {\sum }_{1} + {\sum }_{2} ) \text{/} 2 \vert}{\sqrt{\vert {\sum }_{1} \vert \cdot \vert {\sum }_{2} \vert}}}}^{- 1} exp \{ - \frac{1}{8} {{( {M}_{2} - {M}_{1} )}^{T} [ \frac{{\sum }_{1} + {\sum }_{2}}{2} ]}^{- 1} ( {M}_{2} - {M}_{1} ) \} ,$$
where p and q are input data points, M is the mean of a normal distribution and Σ is a covariance matrix.

18. The system of claim 15, wherein the hierarchical structure comprises a tree having a plurality of branches, and further comprising a conclusion analysis step for combining results produced by each branch into a diagnostic classification.

19. The system of claim 18, wherein the diagnostic classification comprises either presence or absence of a disease.

20. The system of claim 15, wherein the different gating definition is selected from the group consisting of sample tube identity, debris vs. non-debris, granulocytes, monocytes, lymphocytes, negative marker intensity and diminished marker intensity.

21. The system of claim 15, wherein the memory is associated with a flow cytometry instrument and the flow cytometry data is specific to an individual subject.

22. The system of claim 15, wherein the memory comprises a database configured for storing accumulated flow cytometry data generated from samples collected from multiple subjects.
